(19) United States
(12) Patent Application Publication
(10) Pub. No.: US 2025/0042500 A1
(43) Pub. Date: Feb. 6, 2025

(54) METHOD AND APPARATUS FOR STABILIZING FRONT FORK SUSPENSION OF A BIKE

(71) Applicant: Countershox LLC, Olathe, KS (US)

(72) Inventors: Nathan Looney, Olathe, KS (US); Lance Holly, Omaha, NE (US)

(21) Appl. No.: 18/802,512

(22) Filed: Aug. 13, 2024

Related U.S. Application Data
(63) Continuation-in-part of application No. 17/455,962, filed on Nov. 22, 2021.

(51) Int. Cl. B62K 25/08; B62K 21/12; F16F 15/02

(52) U.S. Cl. CPC B62K 25/08; B62K 21/12; F16F 15/022; B62K 2201/04

(57) ABSTRACT

A suspension stabilizer and method are described which may be attached to a bike having front fork suspension to improve handling and reduce rider fatigue. The suspension stabilizer may include a counterweight, a spring assembly and a guide assembly. The spring assembly may be arranged to provide a spring force between the counterweight and the guide assembly to resist linear motion of the counterweight along a guide assembly axis. The counterweight and spring assembly may have a natural motion frequency of 3 to 15 Hertz and may be based on one or more characteristics of the front fork suspension.

### CROSS-REFERENCE TO RELATED APPLICATIONS

The present application is a Continuation-in-Part of and claims the benefit under 35 U.S.C. § 120 of U.S. Non-Provisional application Ser. No. 17/455,962, filed Nov. 22, 2021, which is incorporated herein by reference in its entirety.

### BACKGROUND

Many bikes are intended for use that includes riding off-road. During off-road riding, bikes typically encounter ground terrain that is rough, including terrain with rocks, roots, bumps, ledges, drop-offs, and/or other things that impact the handling of the bike and the comfort of the rider. Bikes can include suspension to soften the ride for the rider and to provide for better control of the bike over rough terrain when compared to a bike that does not include suspension.

Bikes may include front suspension in the form of forks. Forks typically include upper and lower fork tubes, one or more springs and a damping system. The springs include coil type springs made from metal or may include springs that use a gas, such as air. In fork suspension the upper and lower fork tubes are typically cylindrical with one or the other of the upper and lower fork tubes having a diameter that is larger than the other of the upper and lower fork tubes. The upper and lower fork tubes have a shared center axis along which the fork tubes move relative to one another in a linear motion. When the upper fork tube diameter is larger than the lower fork tube diameter, such as in many modern bikes, the lower fork tube slides within the upper fork tube while the spring provides resistance to compressive movement. The damping system may control how fast the fork compresses or rebounds.

The spring(s) and damping system in forks can be selected depending on the type of terrain for which the bike is intended to be used. When the bike is going to be used for terrain having large jumps the forks may have a spring(s) that is relatively stiffer and the damping system may be set to provide a relatively greater damping force. When the bike is going to be used for terrain having mostly smaller bumps such as rocks and roots, the forks may have a spring(s) that are relatively softer and the damping system may be set to provide a relatively smaller damping force.

In either set up the spring(s) and damping are typically a compromise focused on what is typically encountered by the bike.

### SUMMARY

A suspension stabilizer and processes for making and using same are provided. In some examples, the suspension stabilizer may be configured to stabilize front fork suspension of a bike. The suspension stabilizer may comprise a counterweight having a weight that is in a range of 0.25 to 5 pounds, the counter weight including a first surface portion and a second surface portion. The suspension stabilizer may include a guide assembly having a body defining a guide path along a guide assembly axis. The guide path may be configured to receive the counterweight and to guide the counterweight for movement in a linear motion along the guide assembly axis. The guide assembly may include a first end, and a second end, and the body extends between the first end and the second end. The suspension stabilizer may include a spring assembly arranged to provide a spring force between the counterweight and the guide assembly to resist linear motion of the counterweight along the guide assembly axis. The counterweight and spring assembly may have a natural motion frequency of 3 to 15 Hertz. The suspension stabilizer may include a mounting assembly configured to attach the guide assembly to a bike in an orientation in which the guide assembly axis is substantially parallel to an axis of linear motion of lower fork legs of the forks relative to upper fork legs of the forks.

In one or more embodiments, a method may comprise producing a counterweight to have a weight that is in a range of 0.25 pounds to 5 pounds. A guide assembly may be formed with a body defining a guide path along a guide assembly axis. The guide assembly may be formed to receive the counterweight and to guide the counterweight for movement in a linear motion along the guide assembly axis. The guide assembly may include a first end, and a second end, and the body extends between the first end and the second end. A spring assembly may be configured to provide a spring force between the counterweight and the guide assembly to resist linear motion of the counterweight along the guide assembly axis. The spring assembly may be selected to have a spring rate such that the spring assembly and counterweight have a natural motion frequency of 3 to 15 Hertz. A mounting assembly may be arranged to connect the guide assembly to a front portion of a bike having front fork suspension in an orientation in which the guide assembly axis is substantially parallel to an axis of linear motion of lower fork legs of the forks relative to upper fork legs of the forks.

In one or more embodiments, a suspension stabilizer may be configured for connection to a front portion of a bike to stabilize front fork suspension of the bike. The suspension stabilizer may include a counterweight having a weight that is in a range of 0.25 to 5 pounds. The suspension stabilizer may include a guide assembly having a guide assembly axis and the guide assembly may be connected to the counterweight such that the counterweight is moveable in a linear motion along the guide assembly axis without becoming detached from the guide assembly. The suspension stabilizer may include a spring assembly connected to the guide assembly and positioned such that the spring assembly resists linear motion of the counterweight along the guide assembly axis in at least one direction. The spring assembly may include a spring rate such that the counterweight and spring assembly have a natural motion frequency of 4 to 10 Hertz.

### BRIEF DESCRIPTION OF THE DRAWINGS

FIG. 1A depicts an illustration of a bike including a suspension stabilizer, according to one or more embodiments described.

FIG. 1B depicts a diagrammatic cut-away view of the suspension stabilizer shown in FIG. 1A in a neutral position.

FIG. 2A depicts an illustration of the bike and suspension stabilizer shown in FIG. 1A during an impact with a bump, according to one or more embodiments described.

FIG. 2B depicts a diagrammatic cut-away view of the suspension stabilizer shown in FIG. 2A during the impact with the bump.

FIG. 3A depicts an illustration of the bike and suspension stabilizer after the impact with the bump shown in FIG. 2A, according to one or more embodiments described.

FIG. 3B depicts a diagrammatic cut-away view of the suspension stabilizer shown in FIG. 3A.

FIG. 4A depicts an illustration of the bike and suspension stabilizer after the position shown in FIG. 3A, according to one or more embodiments described.

FIG. 4B depicts a diagrammatic cut-away view of the suspension stabilizer shown in FIG. 4A.

FIG. 5A depicts an illustration of the bike and suspension stabilizer after the position shown in FIG. 4A, according to one or more embodiments described.

FIG. 5B depicts a diagrammatic cut-away view of the suspension stabilizer shown in FIG. 5A.

FIG. 6A depicts an illustration of the bike and suspension stabilizer after the position shown in FIG. 5A, according to one or more embodiments described.

FIG. 6B depicts a diagrammatic cut-away view of the suspension stabilizer shown in FIG. 6A.

FIG. 7A depicts an illustration of the bike and suspension stabilizer after the position shown in FIG. 6A, according to one or more embodiments described.

FIG. 7B depicts a diagrammatic cut-away view of the suspension stabilizer shown in FIG. 7A.

FIG. 8A depicts an illustration of the bike and suspension stabilizer after the position shown in FIG. 7A, according to one or more embodiments described.

FIG. 8B depicts a diagrammatic cut-away view of the suspension stabilizer shown in FIG. 8A.

FIG. 9A depicts an illustration of the bike and suspension stabilizer after the position shown in FIG. 8A, according to one or more embodiments described.

FIG. 9B depicts a diagrammatic cut-away view of the suspension stabilizer shown in FIG. 9A.

FIG. 10 depicts a partial cut-away view of a suspension stabilizer, according to one or more embodiments described.

FIG. 11 depicts a partial cut-away view of another suspension stabilizer, according to one or more embodiments described.

FIG. 12 depicts a partial cut-away view of another suspension stabilizer, according to one or more embodiments described.

FIG. 13 depicts a view of a mounting assembly of the suspension stabilizer, according to one or more embodiments described.

FIG. 14 is a flow diagram of a method.

FIG. 15A is an exploded view of the suspension stabilizer, in accordance with one or more embodiments of the present disclosure.

FIG. 15B is a cross-section view of the suspension stabilizer, in accordance with one or more embodiments of the present disclosure.

FIG. 16A is a perspective view of a front suspension, in accordance with one or more embodiments of the present disclosure.

FIG. 16B is a front view of the front suspension, in accordance with one or more embodiments of the present disclosure.

FIG. 16C is a side view of the front suspension, in accordance with one or more embodiments of the present disclosure.

FIG. 17 is a perspective view of the bike, in accordance with one or more embodiments of the present disclosure.

FIG. 18 is a graph, in accordance with one or more embodiments of the present disclosure.

FIG. 19A is a perspective view of the front suspension, in accordance with one or more embodiments of the present disclosure.

FIG. 19B is a partial exploded view of the front suspension, in accordance with one or more embodiments of the present disclosure.

FIG. 20 is a perspective view of the bike, in accordance with one or more embodiments of the present disclosure.

FIG. 21A depicts a side view of the bike, in accordance with one or more embodiments of the present disclosure.

FIG. 21B depicts a partial side view of the bike, in accordance with one or more embodiments of the present disclosure.

FIG. 22 depicts a perspective view of the mounting assembly, in accordance with one or more embodiments of the present disclosure.

FIG. 23A depicts an exploded view of the suspension stabilizer, in accordance with one or more embodiments of the present disclosure.

FIG. 23B depicts a cross-section view of the suspension stabilizer, in accordance with one or more embodiments of the present disclosure.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

The term bike, as used herein, means a motorcycle and/or a bicycle. Bikes are two wheeled vehicles that a user (usually called a rider) rides by straddling with one leg on either side. The term “bike” as used herein is a term that can encompass bicycles and motorcycles. Bikes can include pedals, electrical motors and/or fuel powered engines, such as combustion engines for providing drive power.

The terms “left” and “right” when used herein refer to the left and right sides from the perspective of the rider when straddling the bike. The terms “front” and “back” or “rear” are also from the perspective of the rider when straddling the bike. Ranges described herein are inclusive, so for example, a range of X to Y includes the values of X and Y.

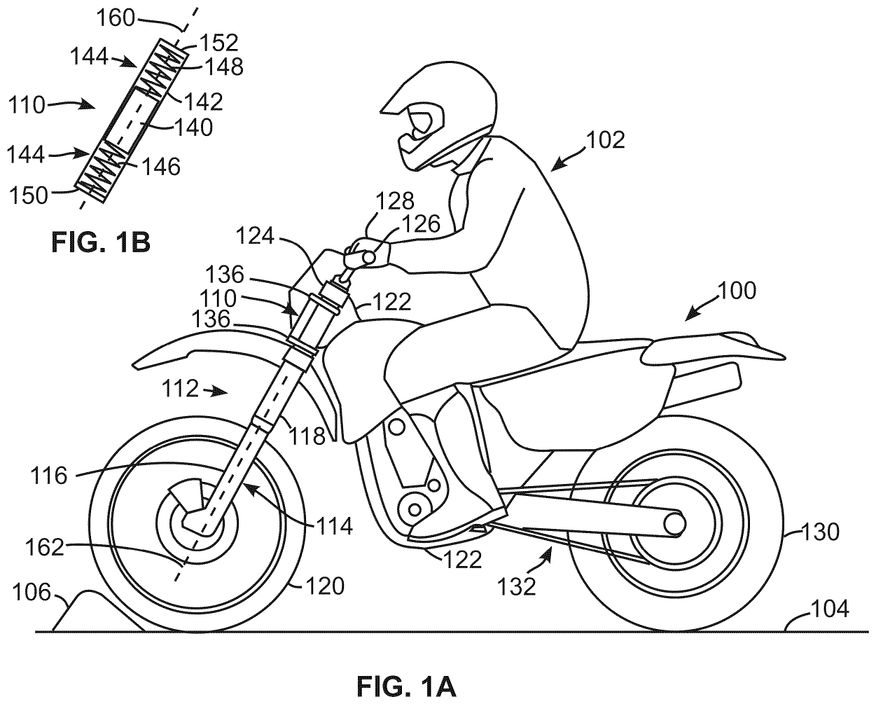

FIG. 1A depicts a bike 100 that a rider 102 may ride over ground 104 which may be rough and may include terrain with rocks, roots, bumps, ledges, drop-offs, jumps, whoops and/or other things that impact the handling of the bike and the comfort of the rider, an example of which is represented in FIG. 1A by a bump 106. The bump 106 is shown of illustrative purposes and is representative of terrain that may be encountered by the bike 100 when ridden. A suspension stabilizer 110 may be mounted to the bike 100 at or near a front suspension 112 of the bike 100 to stabilize the front suspension 112 of the bike 100. In some examples, such as the example shown in FIG. 1A, the front suspension 112 may be forks 114 that include two lower fork tubes 116 and two upper fork tubes 118, FIG. 1A shows the left lower fork tube 116 and left upper fork tube 118, although the forks 114 also include a right lower fork tube and a right upper fork tube. The forks 114 may be connected to a front wheel 120 of the bike and the forks 114 may be connected to a frame 122 of the bike 100 using fork clamps 124 which may also be attached to handlebars 126. The rider 102 may use the handlebars 126 to hold on to the bike 100 with their hands 128 and may use the handlebars 126 for control of the front wheel 120 of the bike 100. In some examples, the bike 100 may also include a rear wheel 130 that is connected to the bike frame 122 through rear suspension 132.

The forks 114 may include one or more springs which can be inside the lower fork tube 116 and/or upper fork tube 118. The forks 114 may also include compression damping and rebound damping to control how the spring(s) in the forks 114 are compressed and decompressed (or extended), respectively when the front wheel 120 contacts the bump 106. The spring(s) may be selected or set to support the weight of the bike 100 and rider 102. In some examples the spring(s) may be selected or set to have a compression that may be referred to as riding sag when the fork 114 and rear suspension 132 are supporting the rider 102, the frame 122 and other components of the bike 100. The riding sag, also called natural sag, is when the bike 100 suspension is settled with the rider 102 on the bike 100 and no external forces acting on the suspension other than gravity. Riding sag may be seen when the rider 102 is riding the bike 100 on flat ground and is not accelerating or decelerating. The bike 100 is shown in FIG. 1A with the suspension, that is the front suspension 112 and rear suspension 132, at riding sag.

The suspension stabilizer 110 may include a mounting assembly 136 which may be used to attach the suspension stabilizer 110 to the bike 100. In the examples shown in FIG. 1A through FIG. 9B the suspension stabilizer 110 is shown mounted to the upper fork tube 118 using the mounting assembly 136.

The suspension stabilizer 110 may reduce how much of an impact of a bump 106 at the front wheel 120 is transferred through the forks 114 to the handlebars 126 then to the rider's hands 128. By reducing the impact felt by the rider 102, the rider 102 may have better control of the bike 100. Sharp or sudden impacts with a large force may tend to make the rider lose their grip on the handlebars 126 or may move the rider's hands. This can result in a less safe ride and may even cause the rider 102 to lose control of the bike 100 momentarily. In some situations, the rider may compensate by holding on to the handlebars 126 tighter when they feel their grip on the handlebars 126 slip or move. This can cause the rider 102 to become fatigued quickly and may cause the rider 102 to experience arm pump which can cause a rider to have difficulties holding on to the handlebars. The suspension stabilizer 110 may also reduce injury caused by long term repetitive impacts by reducing the severity of the impacts. Other benefits may also be provided by the suspension stabilizer 110.

The suspension stabilizer 110 may also provide other benefits. In some examples bike forks 114 may have a resonant frequency at which they try to oscillate. This may be a result of the fork spring (not shown) and the unsprung weight of the front wheel 120, front brake 134 and lower fork tubes 115. The weight of the fork springs and other components may also contribute to the unsprung weight. In some examples, the resonant frequency of the forks may be from 3 to 8 Hertz (Hz); from 3 to 10 Hz; from 3 to 15 Hz; from 4 to 10 Hz; from 4 to 11 Hz; or other ranges which may be determined by measurement. Some frequencies of vibration that are transferred from the front wheel 120 to the handlebars 126 are easier for the rider 102 to manage than other frequencies, and some frequency inducing impacts or bumps are managed by the front wheel 120 or the forks 114 better than other frequencies. For example, frequencies of about 15 Hz to about 20 Hz may be absorbed by the front tire and therefore don't reach the handlebars 126. As another example, frequencies of about 100 Hz at the handlebars 126 do not appear to bother riders. As another example, the rider 102 may be able to manage oscillations at the handlebars 126 for frequencies that are less than about 3 Hz by letting their arms and/or legs move along with the motion. An example of oscillations that are less than about 3 Hz may be large sand roller type bumps. However, riders may have difficulties handling oscillations at the handlebars 126 that are at or above about 3 Hz and at or below about 15 Hz. Riders may tend to try to fight to control the bike 100 when the handlebars 126 are oscillating in these frequencies. This may lead to rider fatigue and loss of some control over the bike 100. The suspension stabilizer 110 may absorb oscillations in the frequencies that are difficult for the rider 102 to handle.

FIG. 1B depicts a diagrammatic cut-away view of the suspension stabilizer 110 shown in FIG. 1A. Suspension stabilizer 110 may include a counterweight 140, a guide assembly 142 and a spring assembly 144. A spring rate of spring assembly 144 and/or the weight of the counterweight 140 may be selected such that the spring assembly 144 and counterweight 140 have a natural motion frequency of 3 to 15 Hz. In some examples, the spring rate of the spring assembly 144 and/or the weight of the counterweight 140 may be selected using a formula (1):

$$f = \sqrt{\frac{k}{m}} / 2 π \qquad ( 1 )$$

Where m is the mass of the counterweight 140, k is the spring rate of the spring assembly 144 (e.g., the spring rates of the lower stabilizing spring 146 and the upper stabilizing spring 148), and f is the natural motion frequency.

In some examples, the weight of the counterweight 140 may be in a range of 1 pound to 2 pounds and the bike may be a motorcycle. In some examples, the weight of the counterweight 140 may be in a range of 0.25 pounds and 0.75 pounds and the bike may be a bicycle. In some examples, the weight of the counterweight may be determined based at least in part on the weight of the bike. In some examples, the weight of the counterweight 140 may be in a rage of 0.25 pounds to 2 pounds.

In the example shown in FIG. 1A the spring assembly 144 includes a lower (first) stabilizing spring 146 and an upper (second) stabilizing spring 148. In the example shown in FIG. 1A the guide assembly 142 includes a first end 150 of the guide assembly 142 and a second end 152 of the guide assembly 142. In some examples, the guide assembly 142 may be mounted so that the first end 150 is oriented toward the lower fork tube 116 and the second end 152 is oriented toward the handlebars 126.

In some examples, the guide assembly 142 may be configured to guide the counterweight for movement in a linear motion along a guide assembly axis 160. In some examples, the lower fork tubes 116 move relative to the upper fork tubes 118 in a linear motion along a fork axis 162. In some examples, the mounting assembly 136 may be configured to attach the guide assembly 142 to the bike 100 in an orientation in which the guide assembly axis 160 is substantially parallel to the axis 162 of the linear motion of lower fork tubes 116 of the forks 114 relative to upper fork tubes 118 of the forks 114.

As shown in FIG. 1A through FIG. 9B, the bike 100 is moving from the right to the left and the ground 104 is moving from the left to the right under the bike 100. As shown in FIG. 1A the front wheel 120 is rolling along a smooth part of the ground 104 and the forks 114 are at the riding sag position. As a result, the suspension stabilizer 110 is shown with the counterweight 140 in a neutral position with no other force other than gravity acting on the suspension stabilizer 110.

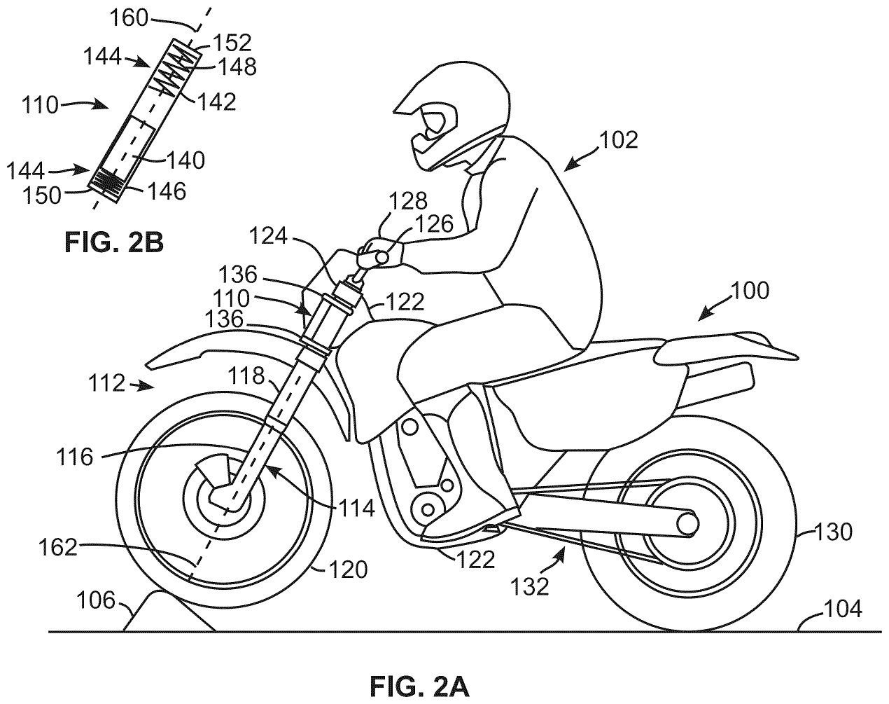

FIG. 2A depicts an illustration of the bike 100 and suspension stabilizer 110 shown in FIG. 1A during an impact with the bump 106. FIG. 2B depicts a diagrammatic cut-away view of the suspension stabilizer 110 shown in FIG. 2A during the impact with the bump 106. In FIG. 2A, the bike 100 has moved relative to the bike 100 shown in FIG. 1A and the front wheel 120 has impacted the bump 106. This impact causes the forks 114 to begin to compress, during which the lower fork tubes 116 move upward into the upper fork tubes 118, and the front wheel 120 moves upward toward the handlebars 126. Although the forks 114 absorb some of the impact, the forks 114 do not absorb all of the impact and so part of the impact force is transferred to the upper fork tubes 118. The suspension stabilizer 110, as shown in FIG. 2B, reacts to the impact force transferred to the upper fork tubes 118 and the guide assembly first end 150 moves toward the counterweight 140 and at least partially compresses the lower stabilizing spring 146.

Since the counterweight 140 has a mass, and therefore inertia, the counterweight 140 resists the movement of the impact by tending to stay in position while the upper fork tubes 118 and the attached guide assembly 142 move relative to the counterweight 140. The counterweight 140 resists the movement of the upper fork tubes 118 through the spring assembly 144; and the suspension stabilizer 110 absorbs some of the impact at the upper fork tubes 118, thereby reducing some of the impact that reaches the handlebars 126 and the rider's hands 128.

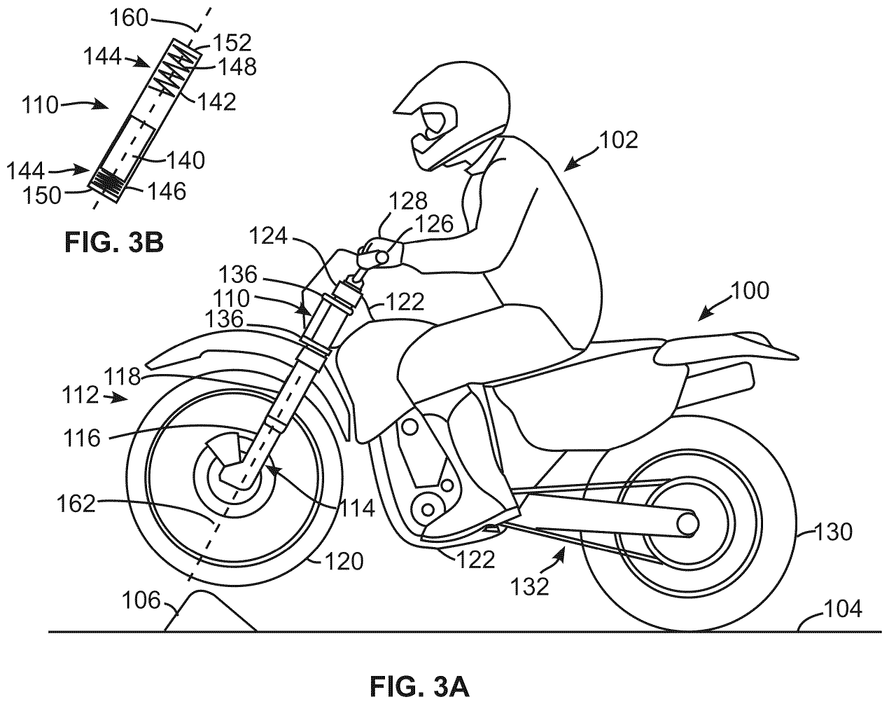

FIG. 3A depicts an illustration of the bike 100 and suspension stabilizer 110 shown in FIG. 1A following the initial impact with the bump 106 shown in FIG. 2A. FIG. 3B depicts a diagrammatic cut-away view of the suspension stabilizer 110 shown in FIG. 3A. In FIG. 3A, the bike 100 has moved relative to the bike 100 shown in FIG. 2A and the front wheel 120 has bounced from the bump 106. This impact causes the forks 114 to continue to compress, and the front wheel 120 moves continues to move upward toward the handlebars 126. In the suspension stabilizer 110, as shown in FIG. 3B, the counterweight 140 continues to compress the lower stabilizing spring 146, and/or the lower stabilizing spring 146 may be fully compressed. The suspension stabilizer 110 shown in FIG. 3A may have absorbed the highest force, or fastest change in the position of the front wheel 120, that the impact transfers from the front wheel 120. In other words, the suspension stabilizer 110 may have taken the sharpness out of the impact. In some examples, the counterweight 140 stays down as the impact continues.

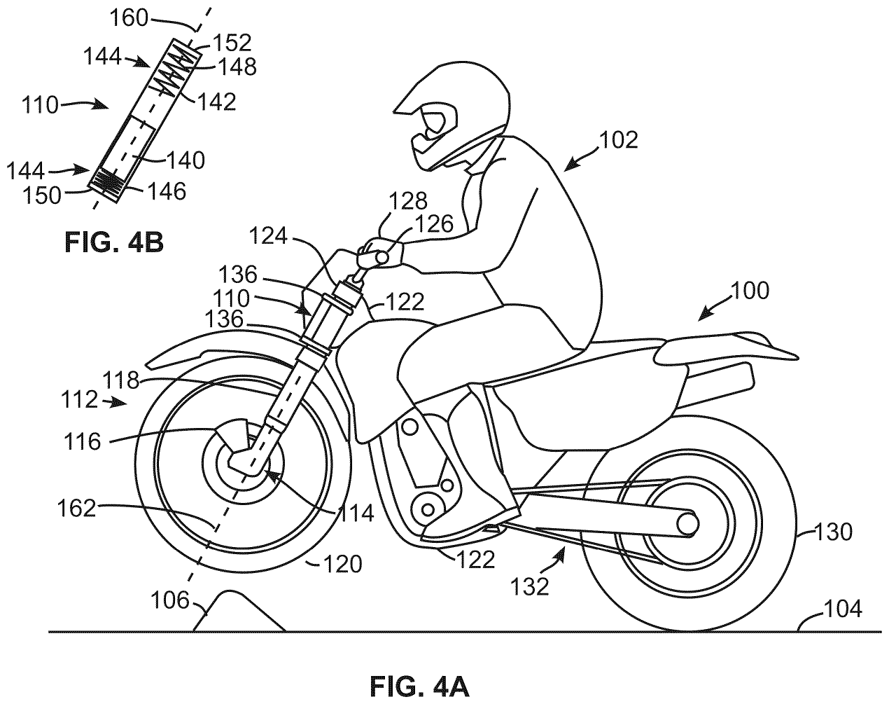

FIG. 4A depicts an illustration of the bike 100 and suspension stabilizer 110 shown in FIG. 1A following the impact with the bump 106 and after the position of the bike 100 shown in FIG. 3A. FIG. 4B depicts a diagrammatic cut-away view of the suspension stabilizer 110 shown in FIG. 4A. In FIG. 4A, the bike 100 has moved relative to the bike 100 shown in FIG. 3A and the impact causes the forks 114 to bottom out and the front wheel 120 stops moving upward toward the handlebars 126. The suspension stabilizer 110, as shown in FIG. 4B, continues to compress the lower stabilizing spring 146, and/or the lower stabilizing spring 146 may be fully compressed. In some examples, the fork 114 bottoms and the counterweight 140 changes direction.

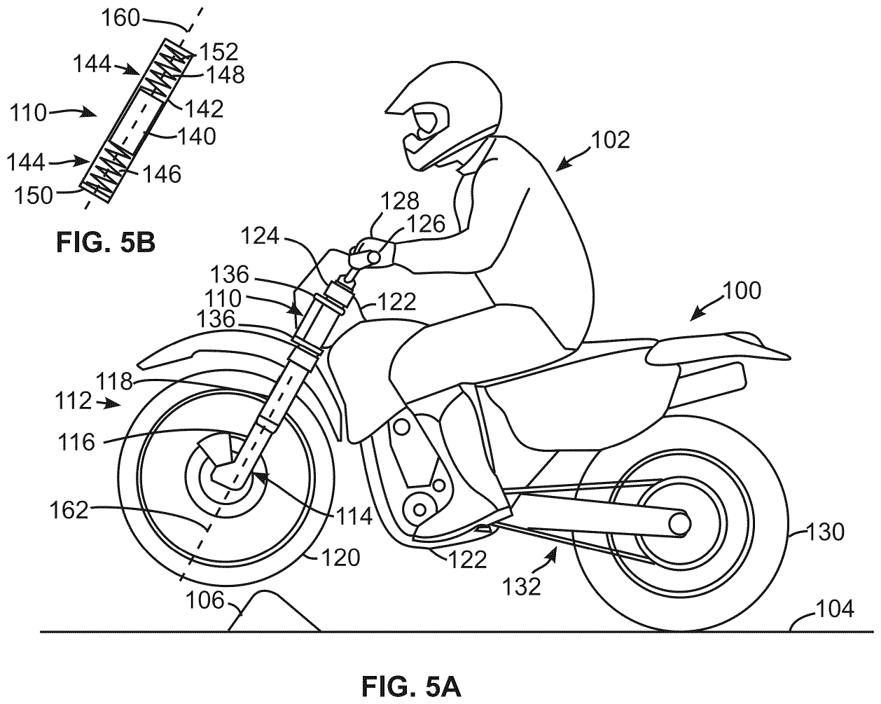

FIG. 5A depicts an illustration of the bike 100 and suspension stabilizer 110 shown in FIG. 1A following the impact with the bump 106 and after the position of the bike 100 shown in FIG. 4A. FIG. 5B depicts a diagrammatic cut-away view of the suspension stabilizer 110 shown in FIG. 5A. In FIG. 5A, the bike 100 has moved relative to the bike 100 shown in FIG. 4A. Following the forks 114 bottoming out, the fork springs begin to extend the forks 114 and move the front wheel 120 back toward the ground 104. As the fork 114 begins to extend the counterweight 140 travels up to counter the force of fork extension. The counterweight 140 is moved away from the first end 150 of the guide assembly 142 toward the second end 152 of the guide assembly 142 by the force of the lower stabilizing spring 146.

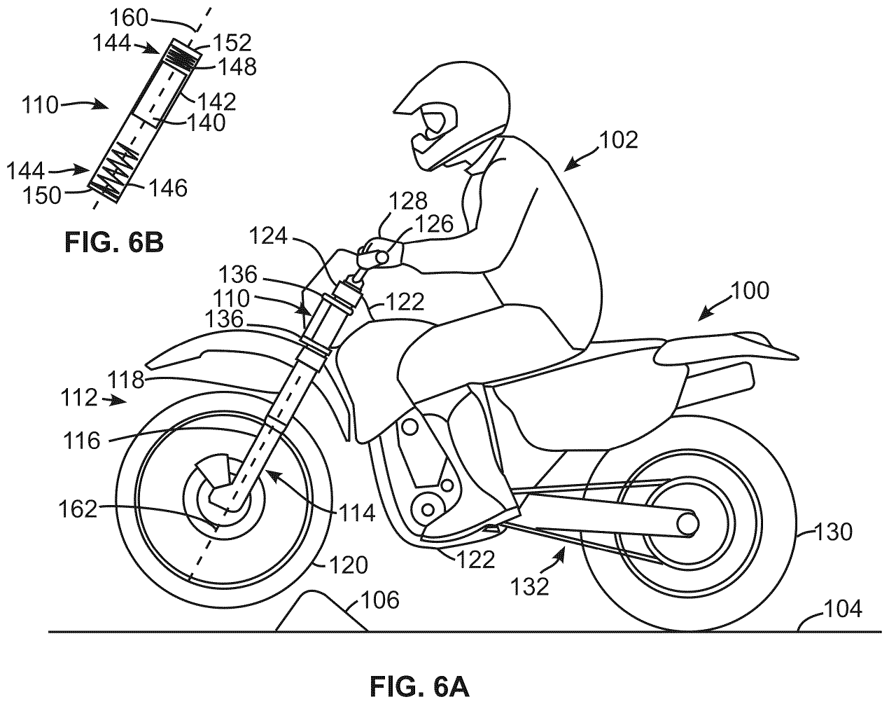

FIG. 6A depicts an illustration of the bike 100 and suspension stabilizer 110 shown in FIG. 1A following the impact with the bump 106 and after the position of the bike 100 shown in FIG. 5A. FIG. 6B depicts a diagrammatic cut-away view of the suspension stabilizer 110 shown in FIG. 6A. In FIG. 6A, the bike 100 has moved relative to the bike 100 shown in FIG. 5A and the forks 114 continue to extend under the force of the fork springs. The suspension stabilizer 110 absorbs some of the force of the extension of the forks 114 that may otherwise be transferred to the handlebars 126 and the rider's hands 128. In some examples, the counterweight 140 tops out to soften the extension of the forks 114 in that the counterweight 140 may fully compress the upper stabilizing spring 148. In some examples, the upper stabilizing spring 148 is partially or fully compressed between the counterweight 140 and the second end 152 of the guide assembly 142.

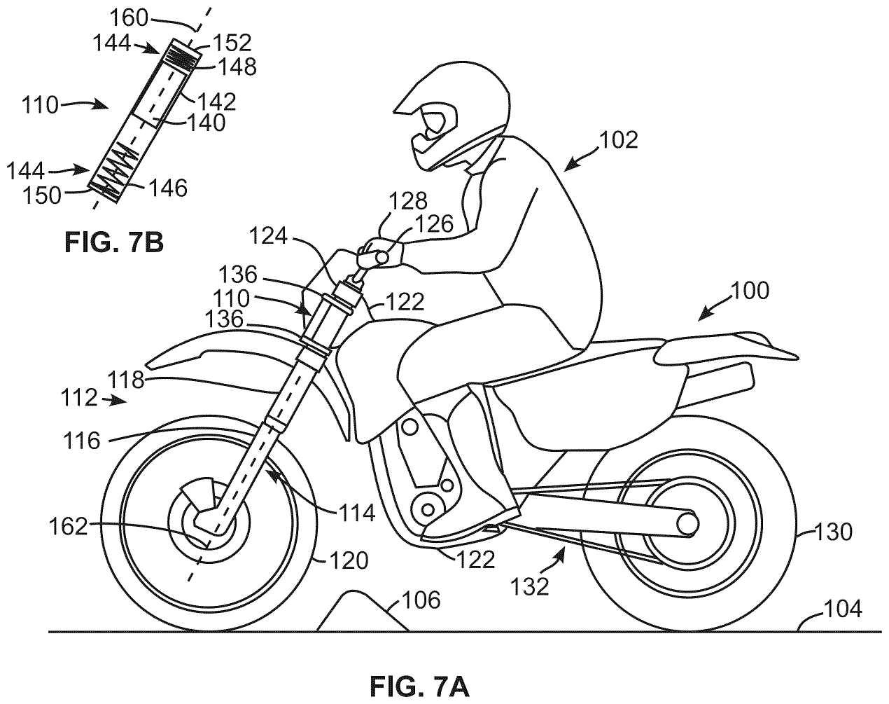

FIG. 7A depicts an illustration of the bike 100 and suspension stabilizer 110 shown in FIG. 1A following the impact with the bump 106 and after the position of the bike 100 shown in FIG. 6A. FIG. 7B depicts a diagrammatic cut-away view of the suspension stabilizer 110 shown in FIG. 7A. In FIG. 7A, the bike 100 has moved relative to the bike 100 shown in FIG. 6A and the forks 114 continue to extend under the force of the fork springs until the front wheel 120 contacts the ground 104. In some examples, the upper stabilizing spring 148 may continue to be partially or fully compressed between the counterweight 140 and the second end 152 of the guide assembly 142.

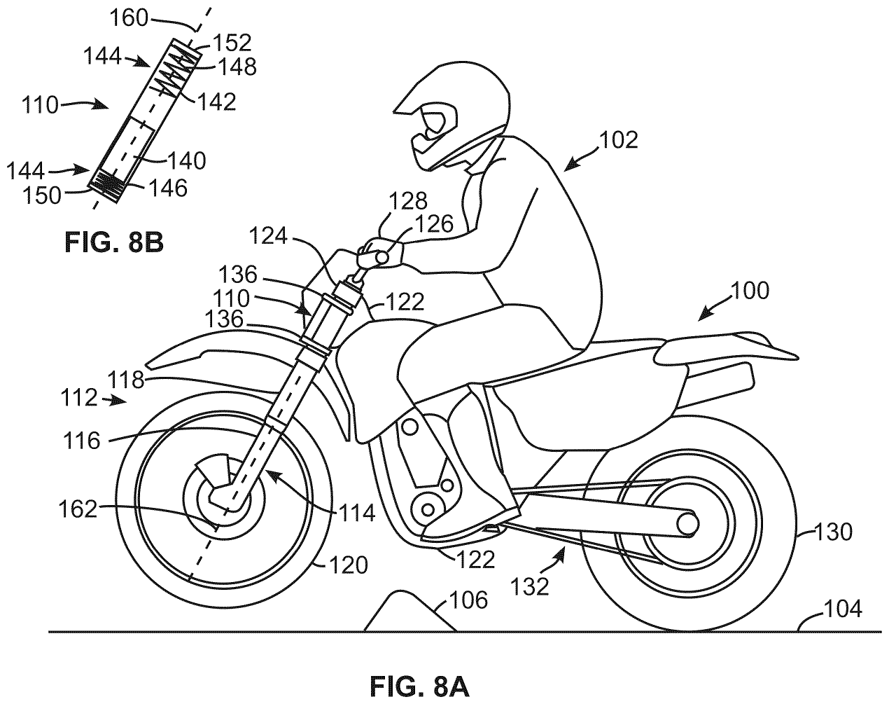

FIG. 8A depicts an illustration of the bike 100 and suspension stabilizer 110 shown in FIG. 1A following the impact with the bump 106 and after the position of the bike 100 shown in FIG. 7A. FIG. 8B depicts a diagrammatic cut-away view of the suspension stabilizer 110 shown in FIG. 8A. In FIG. 8A, the bike 100 has moved relative to the bike 100 shown in FIG. 7A. As shown in FIG. 8A, the forks 114 may begin to compress again and the front wheel 120 may move off of the ground. The suspension stabilizer 110 may counteract the force of the fork compression by compressing the lower stabilizing spring 146 between the first end 150 of the guide assembly 142 and the counterweight 140.

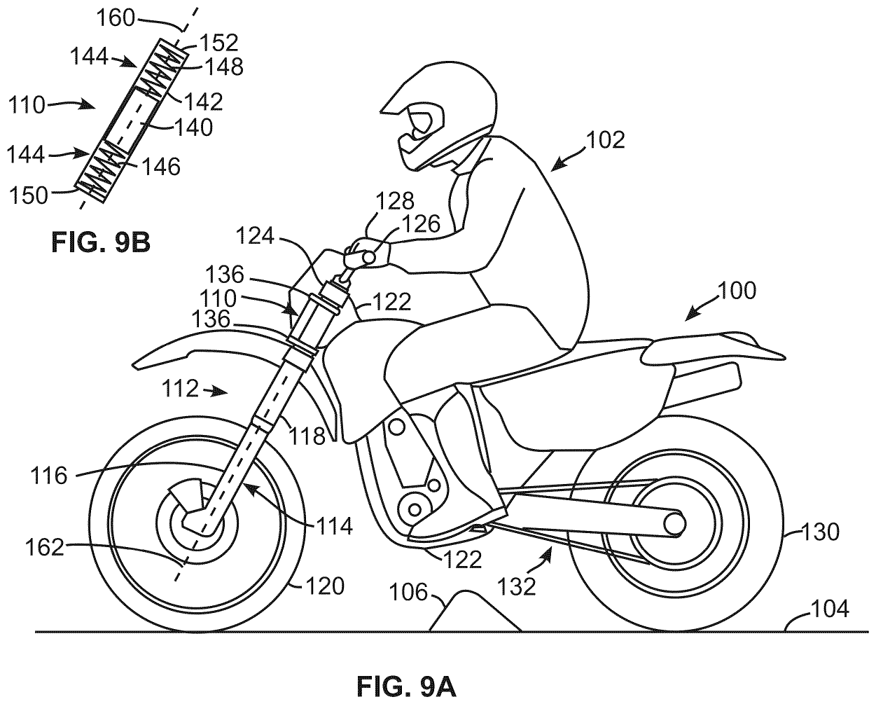

FIG. 9A depicts an illustration of the bike 100 and suspension stabilizer 110 shown in FIG. 1A following the impact with the bump 106 and after the position of the bike 100 shown in FIG. 8A. FIG. 9B depicts a diagrammatic cut-away view of the suspension stabilizer 110 shown in FIG. 9A. In FIG. 9A, the bike 100 has moved relative to the bike 100 shown in FIG. 8A. As shown in FIG. 9A, the forks 114 may again contact the ground and the bike 100 may be settled back to the riding sag as shown in FIG. 1A. In some examples, the forks 114 may exhibit a resonant frequency oscillation induced at least in part by the fork springs. FIG. 7A through FIG. 9B illustrate an example natural frequency of oscillation which may be seen in the front suspension 112 of the bike 100. The natural frequency is the frequency that the forks 114 oscillate in response to an impact at the front wheel 120. In some examples, the natural frequency of the forks 114 may be from 3 to 8 Hertz (Hz), from 3 to 10 Hz, from 3 to 15 Hz from 4 to 10 Hz from 4 to 11 Hz, or other ranges which may be determined by measurement, and the counterweight 140 and spring assembly 144 may be selected to have a natural frequency of motion that is in one of these ranges.

The natural frequency of motion may be the natural frequency of the counterweight 140 when oscillating with one or more spring forces of the spring assembly 144. In some examples, the counterweight 140 and spring assembly 144 may be selected so that oscillations of the counterweight 140 are out of phase with oscillations of the front wheel 120. In some examples, the counterweight 140 and spring assembly 144 may be selected such that oscillations of the counterweight 140 are 180 degrees out of phase with oscillations of the front wheel 120. In some examples, the position and/or orientation of the counterweight 140 and/or spring assembly 144 may be selected so that the counterweight 140 provides the greatest countering force to the motion of the front wheel 120; and in some examples, this includes orienting the counterweight 140 for linear motion that is parallel to motion of the forks 114.

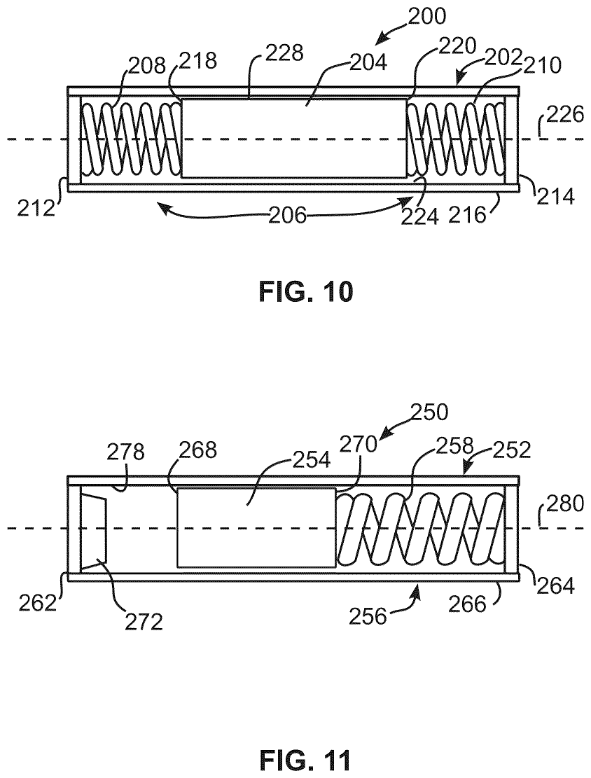

FIG. 10 depicts a suspension stabilizer 200 according to some examples. Suspension stabilizer 200 is shown with a guide assembly 202 that is cut away to show a counterweight 204, and a spring assembly 206 that includes a first stabilizing spring 208 and a second stabilizing spring 210. In some examples, the first stabilizing spring 208 may be considered a lower stabilizing spring and the second stabilizing spring 210 may be considered an upper stabilizing spring, or vice versa, depending on the mounted orientation of the suspension stabilizer 200. In some examples, the counterweight may be made from lead, steel, stainless steel, cast iron, metal, or other material that provides the weight and/or size desired. In some examples, the counterweight 204 may be other sizes and/or shapes than shown.

The guide assembly 202 includes a first end 212 and a second end 214 and a body 216. In some examples, the body 216 may extend between the first end 212 and the second end 214. The counterweight 204 may include a first surface portion 218 and a second surface portion 220. In some examples, the first end 212 and/or the second end 214 may be an end cap, and in some examples the end cap may be removable from the guide assembly body 216. In some examples, the first stabilizing spring 208 may be attached to the counterweight 204, such as at the first surface portion 218 of the counterweight 204, and/or may be attached to the first end 212 of the guide assembly 202. In some examples, the second stabilizing spring 210 may be attached to the counterweight 204, such as at the second surface portion 220 of the counterweight 204, and/or may be attached to the second end 214 of the guide assembly 202.

In some examples, the body 216 of the guide assembly 202 may define a guide path 224 which may guide the counterweight 204 for movement in a linear motion along a guide assembly axis 226. In some examples, a portion of the guide assembly axis 226 may correspond to the linear motion path of the counterweight 204. In some examples, the guide assembly body 216 may include a hollow cylindrical shape or tube and the guide path 224 may be an inner surface of the guide assembly body 216. In some examples, the counterweight 204 may have a cross-section shape that is similar to a cross-section shape of the guide assembly 202, and in some examples the cross-section shape may be circular, square, rectangular, or other shape.

In some examples, the guide assembly 202 may be cylindrical and the guide assembly axis 226 may be the axis of the cylinder. In some examples, the counterweight 204 may include a cylindrical shape having an outer surface 228 that slides relative to the inner surface of the guide assembly 202. In some examples, an outer diameter of the outer surface 228 of the counterweight 204 may be smaller than an inner diameter of the guide assembly 202. In some examples, the guide assembly 202 may define an inner cavity that includes the guide path 224 and the inner cavity may contain a fluid, such as air, nitrogen, liquid, oil, and/or other fluid that may be or may flow between the guide assembly 202 and the counterweight 204; in some examples, the inner cavity may contain a vacuum or a pressure.

FIG. 11 depicts a suspension stabilizer 250 according to some examples. Suspension stabilizer 250 is shown with a guide assembly 252 that is cut away to show a counterweight 254, and a spring assembly 256 that includes a stabilizing spring 258. The guide assembly 252 includes a first end 262 and a second end 264 and a body 266. The counterweight 254 may include a first surface portion 268 and a second surface portion 270. In some embodiments, the spring assembly 256 may have a single spring. In the example shown in FIG. 11, the stabilizing spring 258 is attached to the second surface portion 270 of the counterweight 254 and the second end 264 of the guide assembly 252. The guide assembly may have a guide path 278 and may define a guide assembly axis 280. The suspension stabilizer 250 may include a bottoming bumper 272 which may contact the first surface portion 268 of the counterweight 254 when the stabilizing spring 258 extends to a certain extent, such as during or as a result of an impact at the bike front wheel 120 (FIG. 2A). The bottoming bumper 272 may prevent the counterweight 254 from contacting the first end 262 of the guide assembly 252 and may provide a soft stop for the counterweight. The bottoming bumper 272 may be made from rubber, foam, or other material that may soften the impact of the counterweight 254.

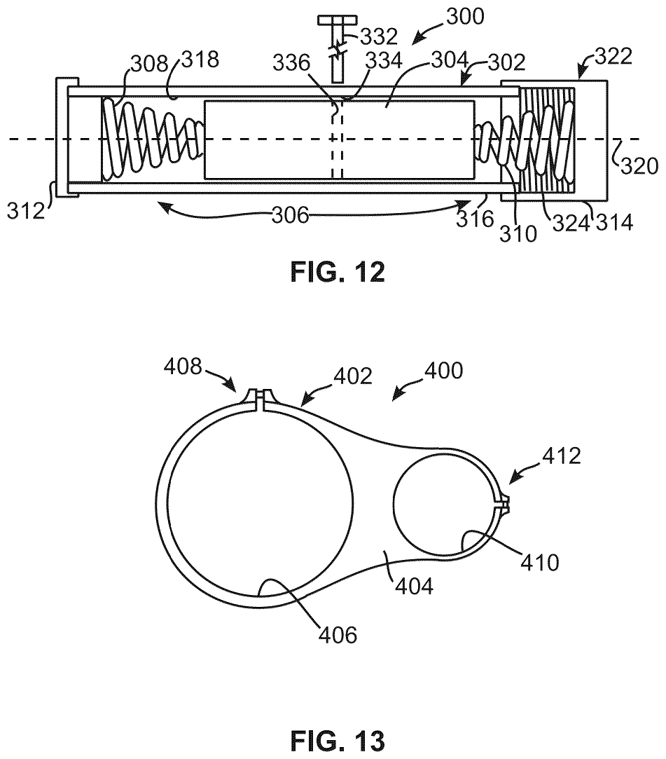

FIG. 12 depicts a suspension stabilizer 300 according to some examples. Suspension stabilizer 300 is shown with a guide assembly 302 that is cut away to show a counterweight 304, and a spring assembly 306 that includes a first stabilizing spring 308 and a second stabilizing spring 310. In the example shown in FIG. 12, the first stabilizing spring 308 and the second stabilizing spring 310. The guide assembly 302 may include a first end 312 and a second end 314 and a body 316. The guide assembly may have a guide path 318 and may define a guide assembly axis 320. In some examples, the first end 312 and/or the second end 314 may include threads and end caps that may be attached to the body 316 using the threads. In some examples, such as shown in FIG. 12, one or both of the first end 312 and second end 314 may be or include a threaded cap 322 that may include threads 324 for connecting to the guide assembly body 316. In some examples, the threads 324 may have a length that allows the threaded cap 322 to be adjusted closer or further from the first end 312, which in some examples may be used to adjust a pre-load on the spring assembly 306.

In some examples, the spring assembly may include one or more coil spring, compression spring, extension spring or other type of spring that is suitable for resisting the linear motion of the counterweight. In some examples, the spring assembly may include one or more springs that are linear rate, progressive rate, and/or dual rate. In some examples, the spring assembly may be made from or include metal, such as steel, titanium, or other suitable metal or material. In some examples, the spring assembly may be or include an air spring.

In some examples, the guide assembly may be made from or include a metal, such as steel, aluminum, titanium, magnesium or other suitable metal, or a plastic, or carbon fiber, or other suitable material.

As shown in FIG. 12, the suspension stabilizer 300 may include a lockout mechanism 330. The lockout mechanism 330 may include one or more lockout pin 332, one or more guide assembly lockout slot or hole 334, and one or more counterweight lockout slot or hole 336. The lockout pin 332 may be inserted through the guide assembly lockout hole 334 and the counterweight lockout hole 336 to restrain the counterweight 304 to prevent linear motion of the counterweight 304 along the guide assembly axis 320. The lockout mechanism 330 may have other configurations that restrain the counterweight to prevent linear motion, such as one or more bolt, screw, pin, and/or other fastener.

FIG. 13 depicts a mounting assembly 400 according to some examples. The mounting assembly 400 may include one or more mounts, such as mount 402. Mount 402 may include a body 404 that defines a first bore 406 and may have a tensioner arrangement 408 for adjusting the first bore 406. Body 404 may also define a second bore 410 and may have a tensioner arrangement 412 for adjusting the second bore 410. In some examples, the first bore 406 may have a diameter which allows the first bore 406 to wrap around an upper fork tube, such as upper fork tube 118 shown in FIG. 1A. The tensioner arrangement 408 may be used to tighten the first bore 406 around the upper fork tube to secure the mount 402 to the upper fork tube. In some examples the tensioner arrangement 408 may include a bolt, screw, or other fastener. In some examples, the second bore 410 may have a diameter which allows the second bore 410 to wrap or attach to the suspension stabilizer 110, such as in guide assembly 142 shown in FIG. 1A. The tensioner arrangement 412 may include a bolt, screw, or other fastener to tighten the second bore around the guide assembly.

In some examples, the mounting assembly may include two mounts 402, such as shown in FIG. 1A. In some examples, the mounting assembly may be formed as part of the guide assembly, and in some examples, the mount may not include the second bore. In some examples, the mounting assembly may have another configuration which allows the mounting assembly to attach the guide assembly to the front of the bike.

In some examples, there may be multiple suspension stabilizers mounted on the bike. In some examples the spring assemblies and counterweights of the multiple suspension stabilizers may be selected based at least in part on the natural frequency of the forks. In some examples, the natural motion frequency of the suspension stabilizer may be based on those frequencies that are transmitted through the standard front fork suspension without adequate attenuation. In some examples, the suspension stabilizer may be integrated into or form part of the forks. For example, the guide assembly, counterweight, and spring assembly may be mounted on the inside of the upper fork tube. In some examples, the suspension stabilizer may be integrated into a portion of the bike frame, such as frame 122 shown in FIG. 1A. For example, the counterweight and spring assembly may be mounted in the steering head of the frame and the steering head or the steering stem of the triple clamps may form part or all of the guide assembly. In some examples, the guide assembly may be or include a rod and the counterweight may define a bore. For example, the counterweight may slide along the rod and the spring assembly may include one or more spring that wraps around the rod to resist the linear motion of the counterweight along the rod. In this example, the guide assembly may also include ends that maintain the counterweight and spring assembly on the rod.

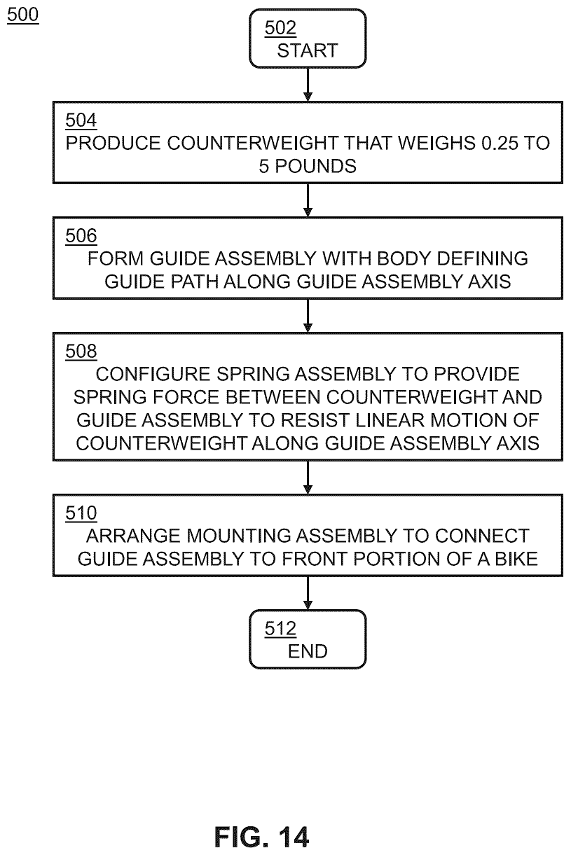

FIG. 14 is a flow chart that represents a method 500. Method 500 begins at 502 and proceeds to 504 where a counterweight is produced to have a weight that is in a range of 0.25 pounds to 5 pounds. Method 500 then proceeds to 506 where a guide assembly is formed with a body defining a guide path along a guide assembly axis, the guide assembly is formed to receive the counterweight and to guide the counterweight for movement in a linear motion along the guide assembly axis, the guide assembly including a first end, and a second end, and the body extends between the first end and the second end. Method 500 then proceeds to 508 where a spring assembly is configured to provide a spring force between the counterweight and the guide assembly to resist linear motion of the counterweight along the guide assembly axis, wherein the spring assembly is selected to have a spring rate such that the spring assembly and counterweight have a natural motion frequency of 3 to 15 Hertz. Method 500 then proceeds to 510 where a mounting assembly is arranged to connect the guide assembly to a front portion of a bike having front fork suspension in an orientation in which the guide assembly axis is substantially parallel to an axis of linear motion of lower fork legs of the forks relative to upper fork legs of the forks. Method 500 then proceeds to 512 where the method 500 ends. Method 500 may be performed in the order shown in FIG. 14 or in other orders.

Although the preceding description has been described herein with reference to particular means, materials, and embodiments, it is not intended to be limited to the particulars disclosed herein; rather, it extends to all functionally equivalent structures, processes, and uses, such as are within the scope of the appended claims.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

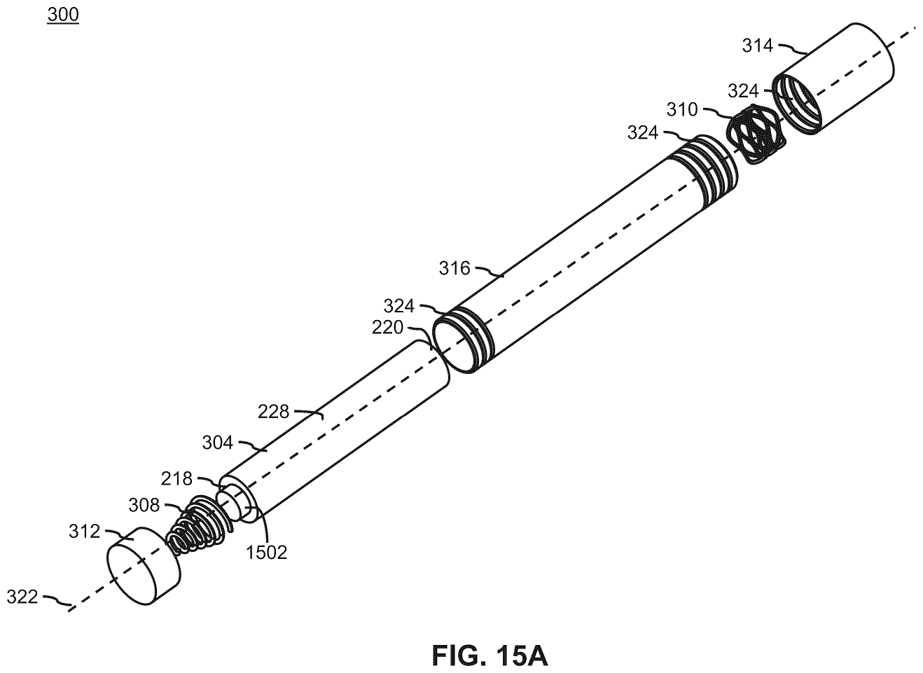

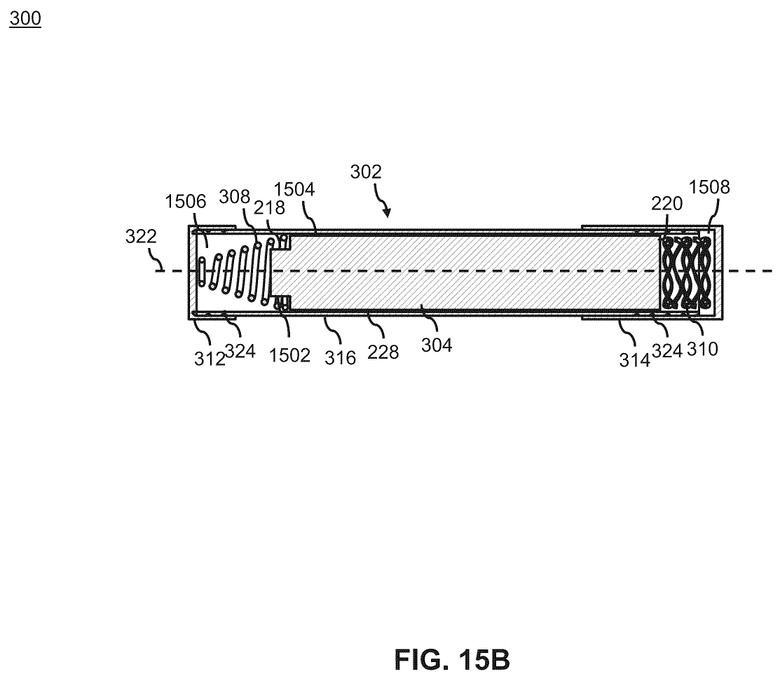

FIGS. 15A-15B depict the suspension stabilizer 300, in accordance with one or more embodiments of the present disclosure. The suspension stabilizer 300 may be referred to as the suspension stabilizer 110, the suspension stabilizer 200, and/or the suspension stabilizer 250.

The suspension stabilizer 300 may include the guide assembly 302. The guide assembly 302 may be referred to as the guide assembly 142, the guide assembly 202, and/or the guide assembly 252. The guide assembly 302 may include the first end 312, the second end 314, and/or the body 316. The first end 312 may be referred to as the first end 150, the first end 212, and/or the first end 262. The second end 314 may be referred to as the second end 152, the second end 214, and/or the second end 264. The body 316 may be referred to as the body 216 and/or the body 266. The first end 312 and the second end 314 may be coupled to opposing ends of the body 316.

The suspension stabilizer 300 may include the counterweight 304. The counterweight 304 may be referred to as the counterweight 140, the counterweight 204, and/or the counterweight 254. The counterweight 304 may be axially disposed between the first stabilizing spring 308 and the second stabilizing spring 310.

The counterweight 304 may include the first surface portion 218, the second surface portion 220, and the outer surface 228. The first surface portion 218 and the second surface portion 220 may also be referred to as the first surface portion 268 and the second surface portion 270, respectively. The outer surface 228 may connect between the first surface portion 218 and the second surface portion 220.

The suspension stabilizer 300 may include the spring assembly 306. The spring assembly 306 may also be referred to as the spring assembly 144, the spring assembly 206, and/or the spring assembly 256. The spring assembly 306 may the first stabilizing spring 308 and/or the second stabilizing spring 310. The first stabilizing spring 308 may be referred to as the lower stabilizing spring 146 and/or the first stabilizing spring 208. The second stabilizing spring 310 may be referred to as the upper stabilizing spring 148, the second stabilizing spring 210, and/or the stabilizing spring 258.

The counterweight 304, first stabilizing spring 308, and/or the second stabilizing spring 310 may be radially disposed within and axially aligned with the guide assembly 302. The first stabilizing spring 308 may be radially disposed within and axially aligned with portions of the first end 312 and the body 316 of the guide assembly 302. The counterweight 304 may be radially disposed within and axially aligned with the body 316 of the guide assembly 302. The second stabilizing spring 310 may be radially disposed within and axially aligned with portions of the second end 314 and the body 316 of the guide assembly 302.

The first stabilizing spring 308 may be axially disposed between the first end 312 and the counterweight 304. The first stabilizing spring 308 may attach to the counterweight 304 and to the first end 312 by abutting the counterweight 304 and the first end 312. The first stabilizing spring 308 may abut between the first end 312 and the first surface portion 218 of the counterweight 304. The first stabilizing spring 308 may transfer forces between the counterweight 304 and the first end 312 via the abutment.

The first stabilizing spring 308 may be a compression spring. For example, the first stabilizing spring 308 may be a conical compression spring.

The second stabilizing spring 310 may be axially disposed between the counterweight 304 and the second end 314. The second stabilizing spring 310 may attach to the counterweight 304 and to the second end 314 by abutting the counterweight 304 and the second end 314. The second stabilizing spring 310 may abut between the second end 314 and the second surface portion 220 of the counterweight 304. The second stabilizing spring 310 may transfer forces between the counterweight 304 and the second end 314 via the abutment.

The second stabilizing spring 310 may be a compression spring. For example, the second stabilizing spring 310 may be a wave compression spring.

The abutment of the first stabilizing spring 308 between the first end 312 and the counterweight 304 and the abutment of the second stabilizing spring 310 between the second end 314 and the counterweight 304 may maintain the counterweight 304 in a neutral position during steady-state dynamics (e.g., see FIG. 1B). The abutment of the first stabilizing spring 308 and the second stabilizing spring 310 may also motivate the counterweight 304 to the neutral position after an impulse.

The first stabilizing spring 308 and the second stabilizing spring 310 may or may not maintain the abutment during the impulse. The first stabilizing spring 308 may or may not abut both the first end 312 and the counterweight 304 when the second stabilizing spring 310 is compressed (e.g., see FIG. 6B). Similarly, the second stabilizing spring 310 may or may not abut both the second end 314 and the counterweight 304 when the first stabilizing spring 308 is compressed (e.g., see FIG. 2B).

The first surface portion 218 of the counterweight 304 may include a shoulder 1502. The shoulder 1502 may be a step-down of the outer surface 228. An outer diameter of the shoulder 1502 may be smaller than an outer diameter of the remainder of the outer surface 228 from which the shoulder 1502 axially extends. The first stabilizing spring 308 may be seated on the shoulder 1502 of the counterweight 304. For example, a largest diameter of the first stabilizing spring 308 may be seated on the shoulder 1502 with the smaller diameter of the first stabilizing spring 308 disposed away from the shoulder 1502, where the first stabilizing spring 308 is the conical compression spring.

The guide assembly 302 may include the guide path 318. The guide path 318 may also be referred to as the guide path 224 and/or the guide path 278. The guide assembly 302 may guide the counterweight 304 for motion along the guide assembly axis 320. The guide assembly axis 320 may also be referred to as the guide assembly axis 226 and/or the guide assembly axis 280. The motion along the guide assembly axis 320 may be linear motion.

The counterweight 204 may include outer surface 228. The outer surface 228 may connect between the first surface portion 218 and the second surface portion 220. The outer surface 228 may define the outer diameter of the counterweight 204. The outer surface 228 may be cylindrical. The outer surface 228 may include a clearance fit with an inner diameter of the body 316.

The first surface portion 218 and the first end 312 may define a first fluid chamber 1506. The first stabilizing spring 308 may be disposed in the first fluid chamber 1506.

The second surface portion 220 and the second end 314 may define a second fluid chamber 1508. The second stabilizing spring 310 may be disposed in the second fluid chamber 1508.

The outer surface 228 and the inner diameter of the body 316 may define a fluid channel 1504. The fluid channel 1504 may connect between the first fluid chamber 1506 and the second fluid chamber 1508.

A size of the first fluid chamber 1506 and the second fluid chamber 1508 may change as the counterweight 304 translates along the guide path 318. The sizes of the first fluid chamber 1506 and the second fluid chamber 1508 may decrease and increase, respectively, as the counterweight 304 translates towards the first end 312. Similarly, the sizes of the first fluid chamber 1506 and the second fluid chamber 1508 may increase and decrease, respectively, as the counterweight 304 translates towards the second end 314.

A fluid may be disposed in the fluid channel 1504, the first fluid chamber 1506, and the second fluid chamber 1508. The fluid may include a gas, a liquid, and/or a mixture thereof. For example, the fluid may include a mixture of oil and air.

The guide assembly 302 may hold the fluid. The guide assembly 302 may provide a fluid-tight seal for the fluid. The guide assembly 302 may be impermeable to the fluid at standard temperature and pressure, such that no amount of fluid may pass from or to the guide assembly 302. For example, the fluid may not leave the guide assembly 302 from the fluid channel 1504, the first fluid chamber 1506, and the second fluid chamber 1508. The fluid may damp the counterweight 304.

The change in size of the first fluid chamber 1506 and the second fluid chamber 1508 may compress and expand the gas within respective of the first fluid chamber 1506 and the second fluid chamber 1508 due to a change in volume. For example, the gas in the first fluid chamber 1506 and the second fluid chamber 1508 may be compressed and expanded, respectively as the counterweight 304 translates towards the first end 312. By way of another example, the gas in the first fluid chamber 1506 and the second fluid chamber 1508 may be expanded and compressed, respectively as the counterweight 304 translates towards the second end 314.

The compression and expansion of the fluid may change the pressure of the gas portion of the fluid. For example, the compression may increase the pressure and the expansion may decrease the pressure. The first fluid chamber 1506 may oscillate between positive and negative pressures, relative to atmosphere, as the counterweight 304 oscillates between the first end 312 and the second end 314. Similarly, the second fluid chamber 1506 may oscillate between negative and positive pressures, relative to atmosphere, as the counterweight 304 oscillates between the first end 312 and the second end 314.

The fluid may flow between the first fluid chamber 1506 and the second fluid chamber 1508 via the fluid channel 1504. The change in pressure may cause the fluid to flow from low pressure to the high pressure. For example, the fluid may flow from the first fluid chamber 1506 to the second fluid chamber 1508 via the fluid channel 1504 as the counterweight 304 translates towards the first end 312. By way of another example, the fluid may flow from the second fluid chamber 1508 to the first fluid chamber 1506 via the fluid channel 1504 as the counterweight 304 translates towards the second end 314.

The compression of the fluid in the first fluid chamber 1506 and/or the second fluid chamber 1508 and/or flow of the fluid between the first fluid chamber 1506 and the second fluid chamber 1508 may resist the motion of the counterweight 304. The fluid may act as an air-spring and/or damp the translation of the counterweight 304. The compression of the fluid in the first fluid chamber 1506 and/or the second fluid chamber 1508 may act as the air-spring. The flow of the fluid between the first fluid chamber 1506 and/or the second fluid chamber 1508 may act as the damper.

The spring rate provided by the compression of the fluid in the first fluid chamber 1506 and/or the second fluid chamber 1508 may be non-linear. As the counterweight 304 compresses the fluid in the first fluid chamber 1506 and/or the second fluid chamber 1508, the fluid in the first fluid chamber 1506 and/or the second fluid chamber 1508 resists against the compression due to the pressure within the fluid. The suspension stabilizer 300 may include a spring rate based on the spring rate of the first stabilizing spring 308, the spring rate of the second stabilizing spring 310, and/or the spring rate provided by the flow of the fluid between the first fluid chamber 1506 and the second fluid chamber 1508. The spring rate of the suspension stabilizer 300 may be non-linear. For example, the spring rate of the suspension stabilizer 300 may be non-linear due to the non-linear spring rate provided by the flow of the fluid between the first fluid chamber 1506 and the second fluid chamber 1508.

The flow of the fluid may provide the damping via boundary layer friction between the fluid and fluid channel 1504 (e.g., the inner diameter of the body 316 and the outer surface 228 of the counterweight 304). The damping may be increased where the thickness of the fluid channel 1504 is decreased and vice versa. The damping may also be based on the viscosity of the oil. Thus, the suspension stabilizer 300 may be configured as a damper or a dashpot. The flow of fluid along the fluid channel 1504 between the first fluid chamber 1506 and the second fluid chamber 1508 may define a damping ratio (2) of the suspension stabilizer 300. The suspension stabilizer 300 may include a non-linear damping ratio. The non-linear damping ratio may be highly non-linear. The damping ratio may be at a maximum when the counterweight 304 is adjacent to the first end 312 and/or the second end 314. The damping ratio may be minimized when the counterweight 304 is at a midpoint (e.g., neutral position) between the first end 312 and/or the second end 314. The damping ratio of the suspension stabilizer 300 when the counterweight 304 is at a midpoint between the first end 312 and the second end 314 may be underdamped. The damping ratio may nonlinearly increase as the counterweight 304 moves from the midpoint between the first end 312 and/or the second end 314 to be adjacent to the first end 312 and/or the second end 314. For example, the damping ratio may increase exponentially as the counterweight 304 approaches the first end 312 and/or the second end 314. The damping ratio may approach a damping ratio (ζ) of 1 (e.g., critically damped) or greater (e.g., overdamped) as the counterweight 304 moves adjacent to the first end 312 and/or the second end 314. The damping ratio may be less than 1 (e.g., underdamped) at the midpoint between the first end 312 and/or the second end 314. The damping ratio may be one of critically damped or overdamped when the counterweight 304 is disposed adjacent to the first end 312 and/or to the second end 314.

The suspension stabilizer 300 may change from being underdamped to one of critically damped or overdamped based on a magnitude of the impulse. The suspension stabilizer 300 may be underdamped when subject to small to medium impulses. The suspension stabilizer 300 may be critically damped or overdamped when subject to large impulses. When a magnitude of impulses at the natural resonant frequencies are large enough to fully compress the stabilizing springs, the fluid may increase damping to fully damped. In this way, the suspension stabilizer 300 may act as a recoil suppression device.

The suspension stabilizer 300 may be a tuned mass damper. The suspension stabilizer 300 may be tuned to damp frequencies between 3 and 15 Hz (e.g., 6 and 10 Hz). For example, the suspension stabilizer 300 may be tuned to damp 8 Hz. When the suspension stabilizer 300 is driven by impulses with frequencies around the natural resonant frequency, the suspension stabilizer 300 may operate out-of-phase with the impulses and act as a tuned mass damper.

The suspension stabilizer 300 may automatically switch between a tuned mass damper mode and a recoil suppression mode. The threshold between the tuned mass damper mode and the recoil suppression mode may be tuned by controlling the fluid channel 1504 that creates the friction as the fluid passes between the first fluid chamber 1506 and the second fluid chamber 1508. The fluid channel 1504 may be changed by changing the dimensions of the counterweight 304 and/or the dimensions of the guide path 318. For example, by opening the clearance between the counterweight 304 and the guide path 318, the effects of the air spring are reduced because the air is less restricted in its movement around the counterweight 304. The threshold may also be tuned by changing the volume of the first fluid chamber 1506 and the second fluid chamber 1508.

The suspension stabilizer 300 may be a passive tuned mass damper. The resonant frequency of the suspension stabilizer 300 may be tuned by changing the spring rate of the first stabilizing spring 308 and the second stabilizing spring 310, changing the mass of the counterweight 304, changing the size of the fluid channel 1504, changing the mixture of the fluid within the guide assembly 302, changing the size of the fluid channel 1504, and/or changing the volumes of the first fluid chamber 1506 and the second fluid chamber 1508. The resonant frequency may also be referred to as natural motion frequency.

The suspension stabilizer 300 may provide several advantages by including the non-linear spring rate and/or the damping. More force may be required to bottom out the counterweight 304. Preventing the counterweight 304 from bottoming out may prevent wear and/or noise.

The damping ratio may be non-linear, with substantial increases in damping in the last 10% of travel. Because of the non-linear damping ratio, any impulses of magnitudes large enough to effectively bottom the counterweight 304 have a phase shift as the impulses are operated on by the suspension stabilizer 300. The phase shift or over-damping of the counterweight 304 at the first end 312 and the second end 314 may allow the suspension stabilizer 300 to self-correct the counterweight 304 out-of-phase with the phase of the impulse to which suspension stabilizer is attenuating. Self-correcting the counterweight 304 out-of-phase with the phase of the impulse to which suspension stabilizer is attenuating may be beneficial to prevent amplifying the impulses when in-phase. The suspension stabilizer 300 may limit the maximum amplification of any impulse, and phase shifts the counterweight 304 out-of-phase when attenuating the impulses, therefore having a ‘net’ destructive effect on impulses which penetrate the suspension stabilizer 300.

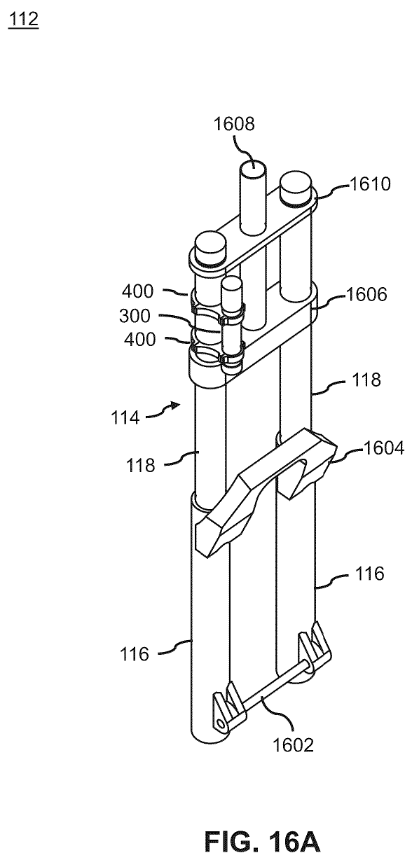

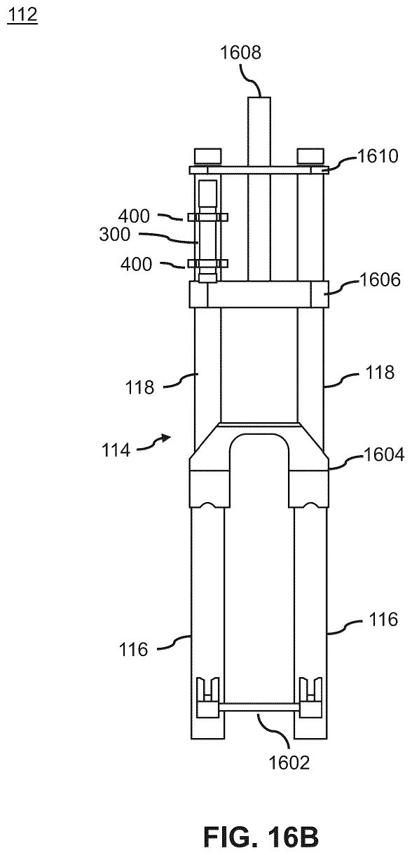

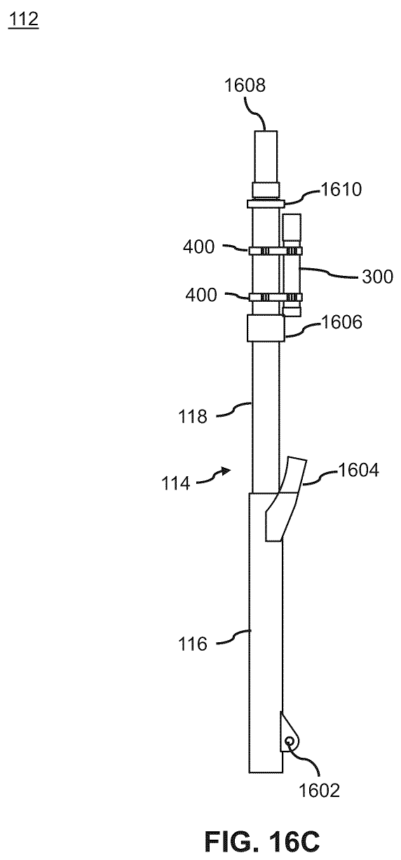

FIGS. 16A-16C depicts the front suspension 112, in accordance with one or more embodiments of the present disclosure. The front suspension 112 may include the fork 114, the suspension stabilizer 300, and the mounting assembly 400. The mounting assembly 400 may also be referred to as the mounting assembly 136.

The fork 114 may also be a downhill suspension fork. The fork 114 may include two of the lower fork tubes 116, two of the upper fork tubes 118, an axle 1602, an arch 1604, a lower crown 1606, a steer tube 1608, and/or an upper crown 1610.

The lower fork tubes 116 may be oriented in parallel and radially offset. The axle 1602 and the arch 1604 may each couple between the lower fork tubes 116. The axle 1602 may be axially disposed below the arch 1604. The axle 1602 and the arch 1604 may be coupled to opposing ends of the lower fork tubes 116.

The upper fork tubes 118 may be oriented in parallel and radially offset. The upper fork tubes 118 may be radially aligned with and coupled to respective of the lower fork tubes 116. For example, left fork tubes may be radially aligned and coupled and right fork tubes may be radially aligned and coupled. The lower fork tubes 116 may be configured to translate axially relative to the upper fork tubes 118.

The lower crown 1606 and the upper crown 1610 may each couple between the upper fork tubes 118. The lower crown 1606 may be axially disposed below the upper crown 1610. The lower fork tubes 116 may be configured to translate axially relative to the upper fork tubes 118 up to the lower crown 1606. The lower fork tubes 116 may bottom out on the lower crown 1606, thereby preventing further axial translation of the lower fork tubes 116 relative to the upper fork tubes 118.

The suspension stabilizer 300 may be coupled to the fork 114. The suspension stabilizer 300 and the mounting assembly 400 may be coupled to one or more of the upper fork tubes 116. The suspension stabilizer 300 may be coupled to the upper fork tubes 116 using the mounting assembly 400. The suspension stabilizer 300 and the mounting assembly 400 may be coupled to the upper fork tubes 116 between the lower crown 1606 and the upper crown 1610. The suspension stabilizer 300 and the mounting assembly 400 may not interfere with the axial translation of the lower fork tubes 116 relative to the upper fork tubes 118 by coupling to the upper fork tubes 116 between the lower crown 1606 and the upper crown 1610.

The steer tube 1608 may be coupled to the lower crown 1606 and/or the upper crown 1610.

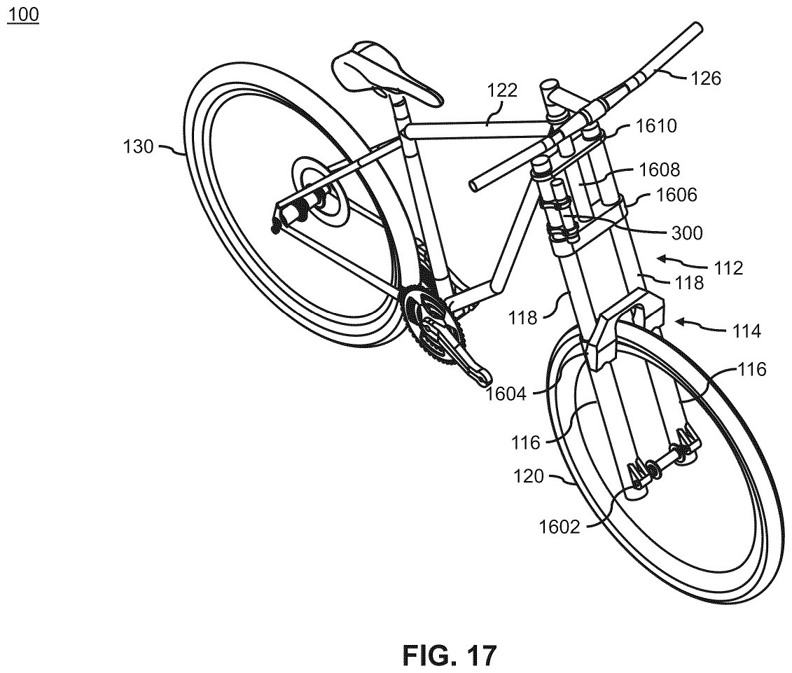

FIG. 17 depicts the bike 100, in accordance with one or more embodiments of the present disclosure. The bike 100 may be a downhill bike. The bike 100 may include the front suspension 112. The fork 114 may be coupled to the front wheel 120, the frame 122, and/or the handlebars 126. The fork 114 may be coupled to the front wheel 120 via the axle 1602. The arch 1604 may be disposed above and conform to the front wheel 120. The fork 114 may be coupled to the handlebars 126 via the steer tube 1608. The steer tube 1608 may be inserted through a front portion of the frame 122 and coupled to the handlebars 126.

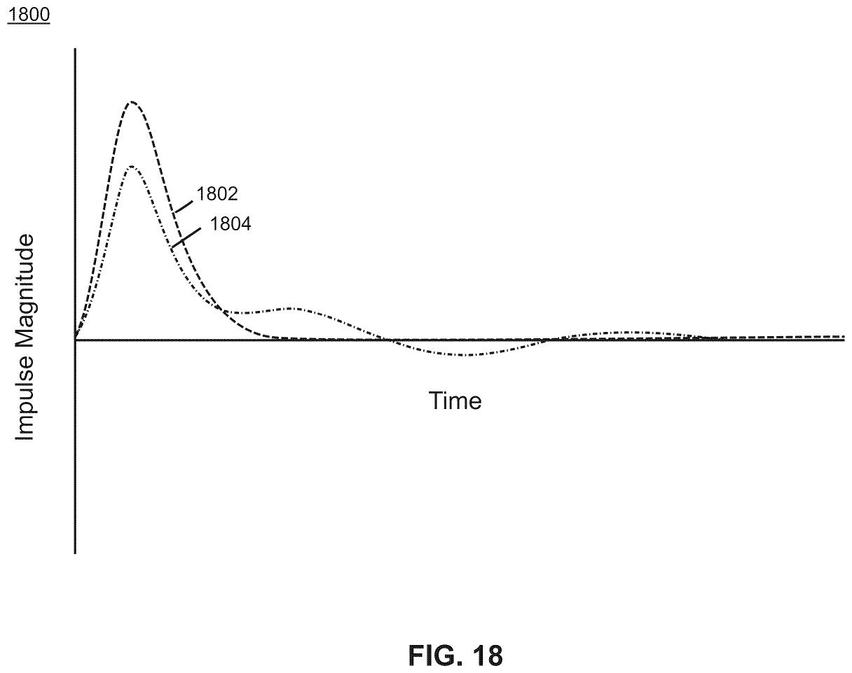

FIG. 18 depicts a graph 1800, in accordance with one or more embodiments of the present disclosure. The graph 1800 depicts an impulse magnitude of the upper fork tubes 116 as a function of time. The graph 1800 includes a trendline 1802 and a trendline 1804. The impulse magnitude of the upper fork tubes 116 may be carried through the steer tube 1608 to the handlebars 126. The trendline 1802 and the trendline 1804 depict the impulse magnitude of the upper fork tubes 116 without and with, respectively, the suspension stabilizer 300 coupled to the upper fork tubes 116. The upper fork tubes 116 are initially at a neutral position in each of the trendline 1802 and the trendline 1804. The upper fork tubes 116 are subject to a same impulse at time zero in each of the trendline 1802 and the trendline 1804. The trendline 1804 more quickly returns to the neutral position. The trendline 1802 and the trendline 1804 do and do not, respectively, oscillate about the neutral position. In this example, the trendline 1802 is underdamped such that the trendline 1802 oscillates about the neutral position as a damped sinusoid. In this example, the trendline 1804 is overdamped such that the trendline 1804 returns to the neutral position without oscillations. Thus, the suspension stabilizer 300 may be beneficial to damp the impulse and improve the suspension characteristics of the front suspension 112.

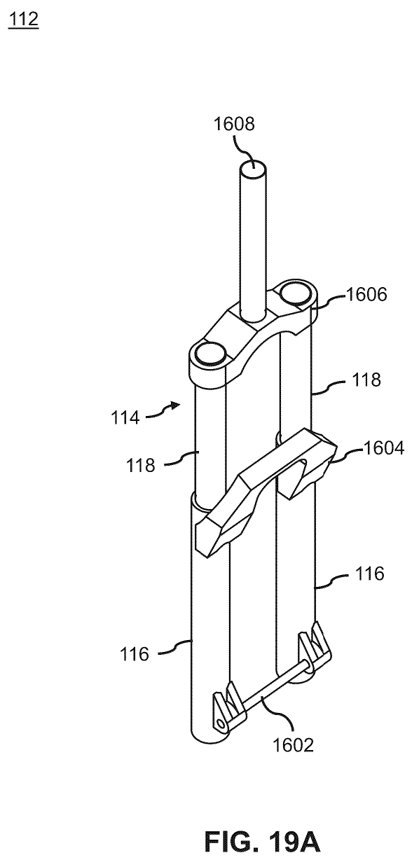

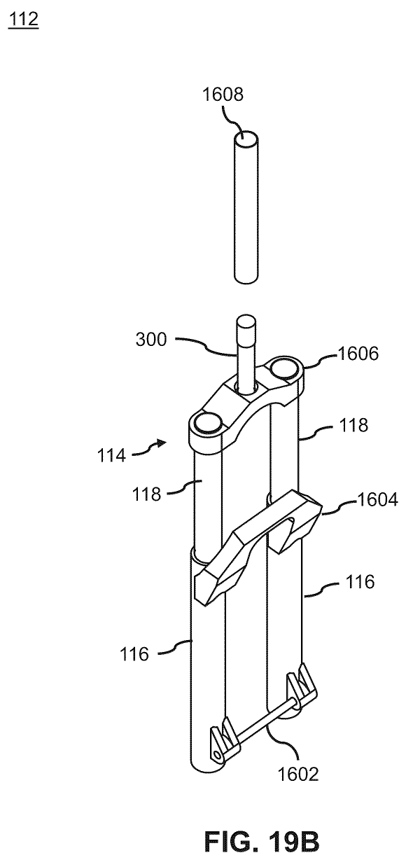

FIGS. 19A-19B depicts the front suspension 112, in accordance with one or more embodiments of the present disclosure. Although the fork 114 is described as including the upper crown 1610, this is not intended as a limitation of the present disclosure. The lower crown 1606 may couple to a topmost end of the upper fork tubes 116. Such arrangement may not allow coupling the suspension stabilizer 300 to the upper fork tubes 116 above the lower crown 1606. Instead, the suspension stabilizer 300 may be coupled to and disposed within the steer tube 1608. The suspension stabilizer 300 may be disposed above and adjacent to the lower crown 1606.

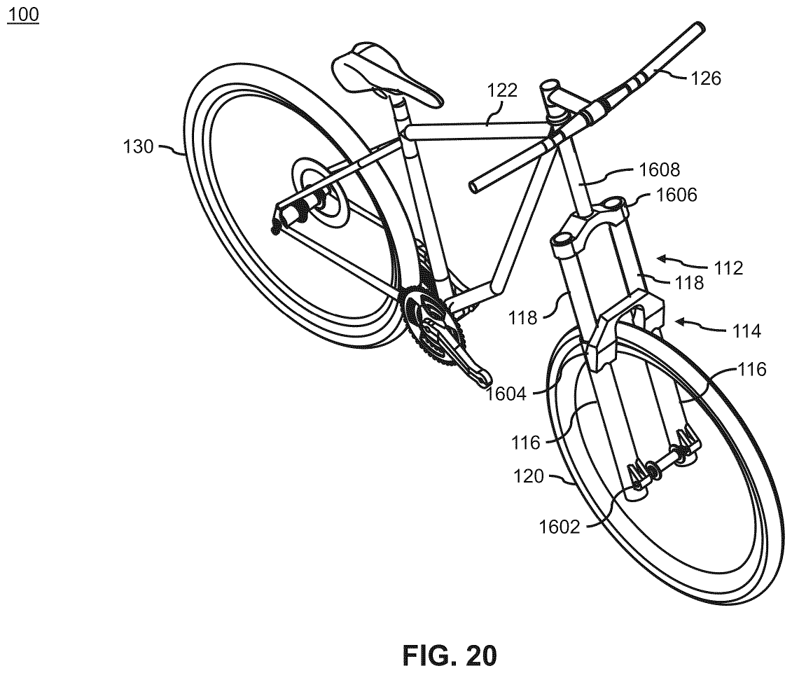

FIG. 20 depicts the bike 100, in accordance with one or more embodiments of the present disclosure. In this example, the suspension stabilizer 300 may be coupled to and disposed within the steer tube 1608. Such arrangement may be beneficial to provide the damping for the front suspension 112 but may limit the amount of adjustment providable by the handlebars 126.

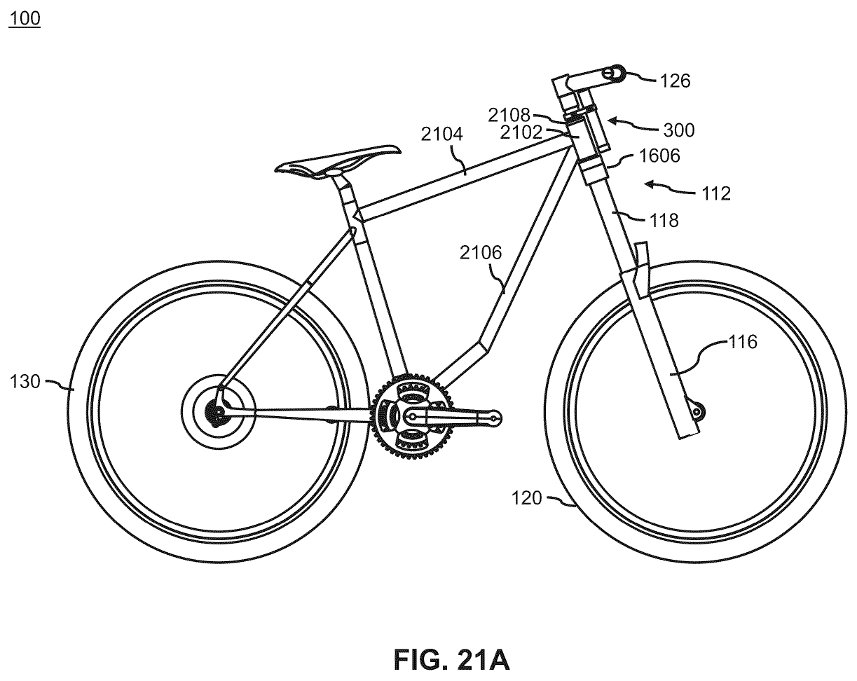

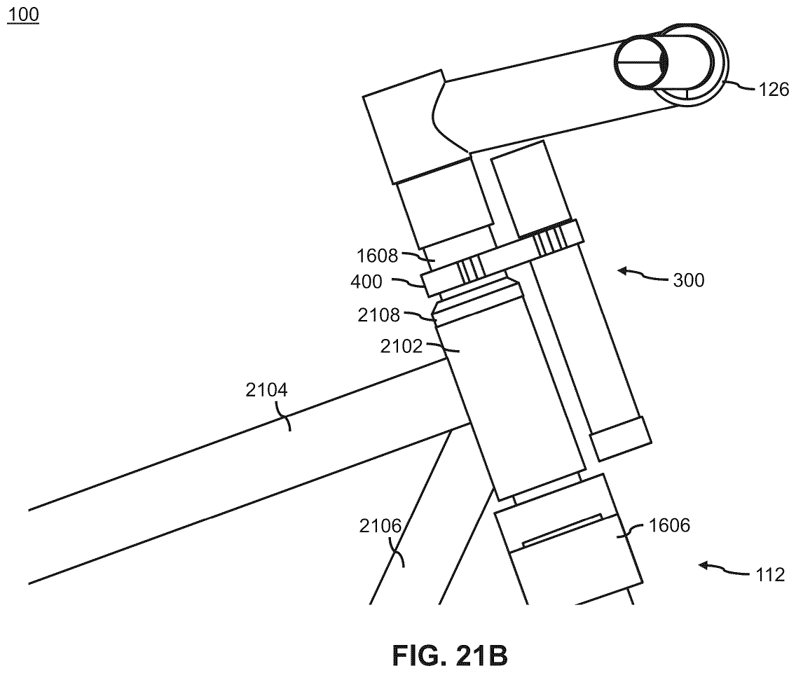

FIGS. 21A-21B depict the bike 100, in accordance with one or more embodiments of the present disclosure. The frame 122 may include a head tube 2102, a top tube 2104, and a down tube 2106. The top tube 2104 and the down tube 2106 may be affixed to the head tube 2102. The steer tube 1608 of the fork 114 may be disposed radially within and axially extend through the head tube 2102. The arch 1604 of the fork 114 may be disposed below the head tube 2102.

The bike 100 may include a headset 2108. The headset 2108 may be a radial bearing. The headset 2108 may include one or more bearings, races, seals, nuts, washers, and the like.

The headset 2108 may be coupled between the frame 122 and the fork 114. The headset 2108 may form a revolute joint between the frame 122 and the fork 114. For example, the headset 2108 may form a revolute joint between the head tube 2102 of the frame 122 and the steer tube 1608 of the fork 114. The fork 114 may be configured to rotate relative to the frame 122 via the headset 2108. The fork 114 may be configured to rotate relative to the frame 122 about a central axis via the headset 2108. The headset 2108 may prevent axial translation of the fork 114 relative to the frame 122.

The handlebars 126 may be coupled to the steer tube 1608 of the fork 114 above the head tube 2102 and/or above the headset 2108.

The suspension stabilizer 300 may be coupled to an outer diameter of the steer tube 1608. The suspension stabilizer 300 may be coupled to the steer tube 1608 of the fork 114 between the handlebars 126 and the headset 2108. For example, the mounting assembly 400 may couple the suspension stabilizer 300 to the steer tube 1608 of the fork 114 between the handlebars 126 and the headset 2108. The first bore 406 of the mounting assembly 400 may be coupled to the steer tube 1608 of the fork 114 between the handlebars 126 and the headset 2108. The mounting assembly 400 may be a spacer between the handlebars 126 and the headset 2108.

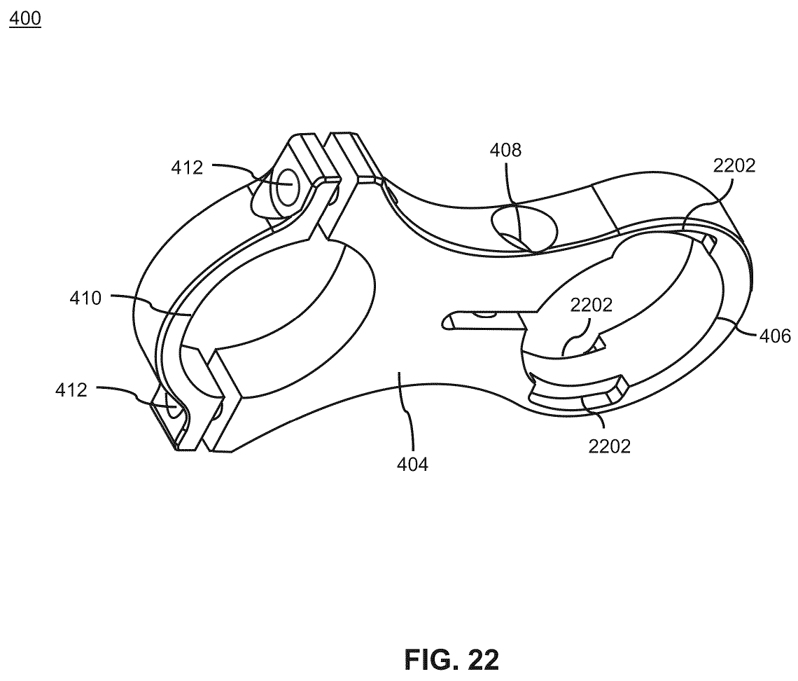

FIG. 22 depicts the mounting assembly 400, in accordance with one or more embodiments of the present disclosure. The mounting assembly 400 may couple the suspension stabilizer 300 to the steer tube 1608 of the fork 114 between the handlebars 126 and the headset 2108.

The mounting assembly 400 may include the body 404 that defines the first bore 406. The first bore 406 may have a diameter which allows the first bore 406 to wrap around the steer tube 1608. The body 404 may have a tensioner arrangement 408 for adjusting the first bore 406. The tensioner arrangement 408 may be used to tighten the first bore 406 around the steer tube 1608 to secure the mounting assembly 400 to the steer tube 1608. The tensioner arrangement 408 may be a hole which is orthogonal to the first bore 406.

The body 404 may define channel segments 2202. The channel segments 2202 may extend radially outward from the first bore 406. The channel segments 2202 may extend circumferentially a select arc length around the first bore 406. The body 404 may define pairs of the channel segments 2202 on opposing radial edges of the first bore 406. The channel segments 2202 may also be defined on opposing axial faces of the body 404. The channel segments 2202 may defined on opposing axial faces of the body 404 may not extend axially through the body 404, such that the channel segments 2202 defined on the opposing axial faces of the body 404 are axially separated by the body 404. The channel segments 2202 defined on a bottom axial face and a top axial face of the body 404 may interface with the headset 2108 and the handlebars 126, respectively. For example, the channel segments 2202 may interface with steer limiters of the headset 2108 and/or the handlebars 126.

The body 404 may also define the second bore 410. The second bore 410 may have a diameter which allows the second bore 410 to wrap or attach to the suspension stabilizer 300 (e.g., the body 316 of the suspension stabilizer 300). The body 404 may have the tensioner arrangement 412 for adjusting the second bore 410. The body 404 may include a pair of the tensioner arrangements 412. The pair of the tensioner arrangement 412 may be disposed at opposing radial ends of the second bore 410. The pair of tensioner arrangements 412 may clamp the second bore 410 to the suspension stabilizer 300.

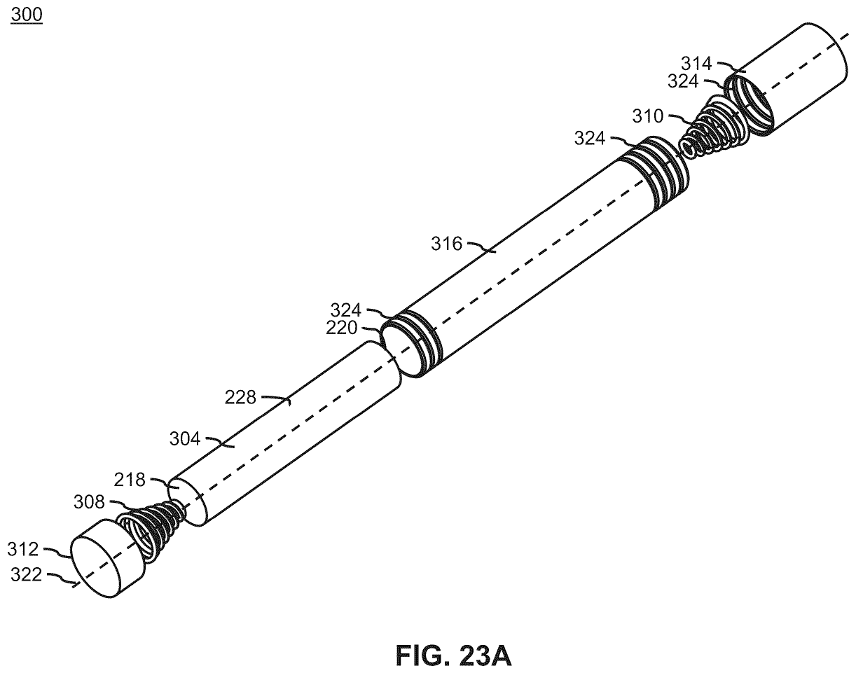

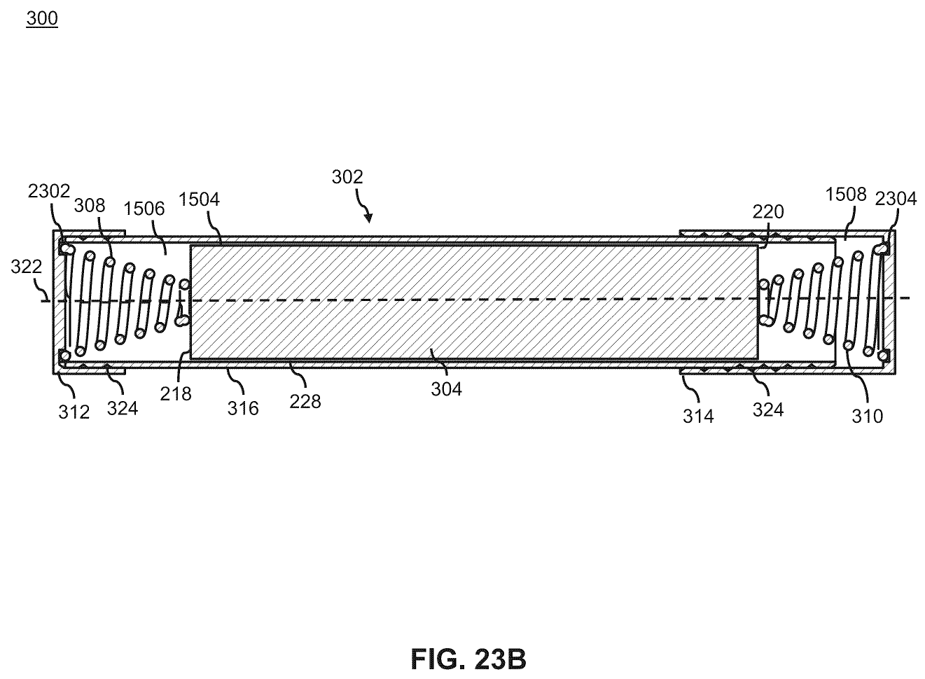

FIGS. 23A-23B depict the suspension stabilizer 300, in accordance with one or more embodiments of the present disclosure.

The first stabilizing spring 308 may be a compression spring. For example, the first stabilizing spring 308 may be a conical compression spring. A largest diameter of the conical compression spring may abut the first end 312. A smallest diameter of the conical compression spring may abut the first surface portion 218 of the counterweight 304.

The first stabilizing spring 308 may be affixed to the first end 312. For example, the first end 312 may define a first annular recess 2302. The first stabilizing spring 308 may be affixed to the first end 312 via the first annular recess 2302. The first annular recess 2302 may be defined within an interior radial face of the first end 312. The first annular recess 2302 may be defined a set thickness from the interior radial face. The largest diameter of the first stabilizing spring 308 may be disposed within the first annular recess 2302. The first annular recess 2302 may receive the first stabilizing spring 308 with an interference fit. The interference fit may prevent the first stabilizing spring 308 from translating relative to the first end 312.

The first stabilizing spring 308 may abut the first surface portion 218 of the counterweight 304. Although the first surface portion 218 of the counterweight 304 is described as including the shoulder 1502, this is not intended as a limitation of the present disclosure. The first surface portion 218 of the counterweight 304 may be a planar surface portion. The smallest diameter of the first stabilizing spring 308 may abut the planar surface portion. The smallest diameter of the first stabilizing spring 308 may or may not be affixed to the first surface portion 218 of the counterweight 304. For example, the smallest diameter of the first stabilizing spring 308 may not be affixed to the first surface portion 218 of the counterweight 304.

The second stabilizing spring 310 may be a compression spring. For example, the second stabilizing spring 310 may be a conical compression spring. A largest diameter of the conical compression spring may abut the second end 314. A smallest diameter of the conical compression spring may abut the second surface portion 220 of the counterweight 304.

The second stabilizing spring 310 may be affixed to the second end 314. For example, the second end 314 may define a second annular recess 2304. The second stabilizing spring 310 may be affixed to the second end 314 via the second annular recess 2304. The second annular recess 2304 may be defined within an interior radial face of the second end 314. The second annular recess 2304 may be defined a set thickness from the interior radial face. The largest diameter of the second stabilizing spring 310 may be disposed within the second annular recess 2304. The second annular recess 2304 may receive the second stabilizing spring 310 with an interference fit. The interference fit may prevent the second stabilizing spring 310 from translating relative to the second end 314.

The second stabilizing spring 310 may abut the second surface portion 220 of the counterweight 304. The second surface portion 220 of the counterweight 304 may be a planar surface portion. The smallest diameter of the second stabilizing spring 310 may abut the planar surface portion. The smallest diameter of the second stabilizing spring 310 may or may not be affixed to the second surface portion 220 of the counterweight 304. For example, the smallest diameter of the second stabilizing spring 310 may not be affixed to the second surface portion 220 of the counterweight 304.

Affixing the first stabilizing spring 308 and the second stabilizing spring 310 to the first end 312 and the second end 314, respectively, may prevent the first stabilizing spring 308 and the second stabilizing spring 310 from rattling within the guide assembly 302. Affixing the first stabilizing spring 308 and the second stabilizing spring 310 to the first end 312 and the second end 314, respectively, may also align the first stabilizing spring 308 and the second stabilizing spring 310 relative to the counterweight 304 to prevent side loading the first stabilizing spring 308 and the second stabilizing spring 310 when the counterweight compresses the first stabilizing spring 308 and the second stabilizing spring 310.

The term “axial” and derivatives thereof, such as “axially,” shall be understood to refer to a direction along the axis of rotation. Further, the term “radial” and derivatives thereof, such as “radially,” shall be understood in relation to the axis. For example, “radially outwards” refers to further away from the axis, while “radially inwards” refers to nearer to the axis. The term “circumferential” and derivatives thereof, such as “circumferentially,” shall be understood in a circumference at a fixed radius in relation to the axis.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed:

1. A suspension stabilizer comprising:
a counterweight, wherein the counterweight is between 0.25 and 5 pounds, the counterweight comprising a first surface portion, a second surface portion, and an outer surface, wherein the outer surface connects between the first surface portion and the second surface portion;
a guide assembly comprising a first end, a second end, and a body, wherein the body extends between and couples the first end and the second end; and
a spring assembly comprising:
a first stabilizing spring, wherein the first stabilizing spring is axially disposed between the first end and the counterweight, wherein the first stabilizing spring is configured to abut between the first end and the first surface portion; and
a second stabilizing spring, wherein the second stabilizing spring is axially disposed between the counterweight and the second end, wherein the second stabilizing spring is configured to abut between the second end and the second surface portion, wherein the counterweight, the first stabilizing spring, and the second stabilizing spring are radially disposed within the guide assembly, wherein the counterweight is configured to linearly translate relative to the guide assembly, wherein the spring assembly and the counterweight have a natural motion frequency of between 3 and 15 Hz.

2. The suspension stabilizer of claim 1, wherein the natural motion frequency is between 3 and 10 Hz.

3. The suspension stabilizer of claim 2, wherein the natural motion frequency is between 3 and 8 Hz.

4. The suspension stabilizer of claim 1, wherein the counterweight is between 0.25 and 2 pounds.

5. The suspension stabilizer of claim 1, wherein the first stabilizing spring and the second stabilizing spring are compression springs.

6. The suspension stabilizer of claim 5, wherein at least one of the first stabilizing spring or the second stabilizing spring is a conical compression spring.

7. The suspension stabilizer of claim 5, wherein the first stabilizing spring is affixed to the first end, wherein the second stabilizing spring is affixed to the second end.

8. The suspension stabilizer of claim 7, wherein the first end defines a first annular recess, wherein the first stabilizing spring is affixed to the first end via the first annular recess, wherein the second end defines a second annular recess, wherein the second stabilizing spring is affixed to the second end via the second annular recess.

9. The suspension stabilizer of claim 5, wherein abutment of the first stabilizing spring between the first end and the counterweight and abutment of the second stabilizing spring between the second end and the counterweight maintains the counterweight in a neutral position.

10. The suspension stabilizer of claim 1, wherein the first surface portion and the first end define a first fluid chamber, wherein the second surface portion and the second end define a second fluid chamber, wherein the outer surface and an inner diameter of the body define a fluid channel, wherein the fluid channel connects between the first fluid chamber and the second fluid chamber, wherein a fluid is disposed within the first fluid chamber, the second fluid chamber, and the fluid channel, wherein the guide assembly provides a fluid-tight seal for the fluid, wherein the fluid is configured to flow between the first fluid chamber and the second fluid chamber via the fluid channel, wherein a flow of the fluid between the first fluid chamber and the second fluid chamber damps the counterweight.

11. The suspension stabilizer of claim 10, wherein the fluid comprises a mixture of oil and air, wherein the counterweight is configured to compress the air in the first fluid chamber as the counterweight travels towards the first fluid chamber, wherein the counterweight is configured to compress the air in the second fluid chamber as the counterweight travels towards the second fluid chamber, wherein compression of the air in the first fluid chamber and the second fluid chamber provides a non-linear spring rate to the suspension stabilizer.

12. The suspension stabilizer of claim 11, wherein a damping ratio of the suspension stabilizer when the counterweight is at a midpoint between the first end and the second end is underdamped, wherein the damping ratio when the counterweight is disposed adjacent to the first end and to the second end is one of critically damped or overdamped.

13. A front suspension comprising:
a suspension stabilizer comprising:
a counterweight, wherein the counterweight is between 0.25 and 5 pounds, the counterweight comprising a first surface portion, a second surface portion, and an outer surface, wherein the outer surface connects between the first surface portion and the second surface portion;
a guide assembly comprising a first end, a second end, and a body, wherein the body extends between and couples the first end and the second end; and
a spring assembly comprising:
a first stabilizing spring, wherein the first stabilizing spring is axially disposed between the first end and the counterweight, wherein the first stabilizing spring is configured to abut between the first end and the first surface portion; and
a second stabilizing spring, wherein the second stabilizing spring is axially disposed between the counterweight and the second end, wherein the second stabilizing spring is configured to abut between the second end and the second surface portion, wherein the counterweight, the first stabilizing spring, and the second stabilizing spring are radially disposed within the guide assembly, wherein the counterweight is configured to linearly translate relative to the guide assembly, wherein the spring assembly and the counterweight have a natural motion frequency of between 3 and 15 Hz; and
a fork, wherein the suspension stabilizer is coupled to the fork, the fork comprising:
two lower fork tubes, wherein the two lower fork tubes are oriented in parallel and radially offset;
an axle;
an arch, wherein the axle and the arch each couple between the two lower fork tubes;
two upper fork tubes, wherein the two upper fork tubes are radially aligned with and coupled to respective of the two lower fork tubes;
a lower crown, wherein the lower crown couples between the two upper fork tubes, wherein the two lower fork tubes are configured to translate axially relative to the two upper fork tubes up to the lower crown; and
a steer tube, wherein the steer tube is coupled to the lower crown.

14. The front suspension of claim 13, wherein the first end is mounted facing towards the two lower fork tubes, wherein the guide assembly is parallel to the two upper fork tubes.

15. The front suspension of claim 13, wherein the fork comprises an upper crown, wherein the upper crown couples between the two upper fork tubes, wherein the suspension stabilizer is coupled to one of the two upper fork tubes between the lower crown and the upper crown.

16. The front suspension of claim 13, wherein the lower crown couples to a topmost end of the two upper fork tubes, wherein the suspension stabilizer is coupled to and disposed within the steer tube.

17. A bike comprising:
a front suspension comprising:
a suspension stabilizer comprising:
a counterweight, wherein the counterweight is between 0.25 and 5 pounds, the counterweight comprising a first surface portion, a second surface portion, and an outer surface, wherein the outer surface connects between the first surface portion and the second surface portion;
a guide assembly comprising a first end, a second end, and a body, wherein the body extends between and couples the first end and the second end; and
a spring assembly comprising:
a first stabilizing spring, wherein the first stabilizing spring is axially disposed between the first end and the counterweight, wherein the first stabilizing spring is configured to abut between the first end and the first surface portion; and
a second stabilizing spring, wherein the second stabilizing spring is axially disposed between the counterweight and the second end, wherein the second stabilizing spring is configured to abut between the second end and the second surface portion, wherein the counterweight, the first stabilizing spring, and the second stabilizing spring are radially disposed within the guide assembly, wherein the counterweight is configured to linearly translate relative to the guide assembly, wherein the spring assembly and the counterweight have a natural motion frequency of between 3 and 15 Hz; and
a fork, wherein the suspension stabilizer is coupled to the fork, the fork comprising:
two lower fork tubes, wherein the two lower fork tubes are oriented in parallel and radially offset;
an axle;
an arch, wherein the axle and the arch each couple between the two lower fork tubes;
two upper fork tubes, wherein the two upper fork tubes are radially aligned with and coupled to respective of the two lower fork tubes;
a lower crown, wherein the lower crown couples between the two upper fork tubes, wherein the two lower fork tubes are configured to translate axially relative to the two upper fork tubes up to the lower crown; and
a steer tube, wherein the steer tube is coupled to the lower crown;
a front wheel, wherein the fork is coupled to the front wheel via the axle, wherein the arch conforms to the front wheel; and
handlebars, wherein the fork is coupled to the handlebars via the steer tube.

18. The bike of claim 17, wherein one of:
the fork comprises an upper crown, wherein the upper crown couples between the two upper fork tubes, wherein the suspension stabilizer is coupled to one of the two upper fork tubes between the lower crown and the upper crown; or
the lower crown couples to a topmost end of the two upper fork tubes, wherein the suspension stabilizer is coupled to and disposed within the steer tube.

19. The bike of claim 17, comprising a headset, wherein the suspension stabilizer is coupled to the steer tube between the handlebars and the headset.

20. The bike of claim 19, comprising a mounting assembly, wherein the mounting assembly comprises a body defining a first bore and a second bore, wherein the first bore wraps around the steer tube, wherein the second bore wraps around the suspension stabilizer, wherein the body defines a plurality of channels segments, wherein the plurality of channel segments extend radially outward from the first bore, wherein the plurality of channel segments are defined on opposing axial faces of the body, wherein the plurality of the channel segments defined on a bottom axial face of the body interface with the headset, wherein plurality of the channel segments defined on a top axial face of the body interface with the handlebars.
